(19) United States
(12) Patent Application Publication
(10) Pub. No.: US 2026/0133608 A1
(43) Pub. Date: May 14, 2026

(54) METHOD FOR CONTROLLING DRIVING UNIT ACCORDING TO FALLING OF ELECTRONIC DEVICE AND ELECTRONIC DEVICE THEREOF

(71) Applicant: Samsung Electronics Co., Ltd., Suwon-si (KR)

(72) Inventors: Sejin PARK, Suwon-si (KR); Sean KWON, Suwon-si (KR); Hyunju HONG, Suwon-si (KR); Moonsun KIM, Suwon-si (KR); Youngjin KIM, Suwon-si (KR); Taewoo KIM, Suwon-si (KR); Changhee YOO, Suwon-si (KR); Hyoungtak CHO, Suwon-si (KR)

(21) Appl. No.: 19/436,568

(22) Filed: Dec. 30, 2025

Related U.S. Application Data
(63) Continuation of application No. PCT/KR2024/005093, filed on Apr. 16, 2024.

(30) Foreign Application Priority Data
Jul. 3, 2023 (KR) 10-2023-0085841
Aug. 31, 2023 (KR) 10-2023-0115580

(51) Int. Cl. G06F 1/16

(52) U.S. Cl. CPC G06F 1/1656; G06F 1/1624

(57) ABSTRACT

An electronic device and method for operating the same are provided. The method includes obtaining first information related to a movement of an electronic device by using a first sensor, obtaining second information related to a user grip on the electronic device by using a second sensor, and while a second housing part of the electronic device is in an extended position, requesting a first processor of the electronic device to operate a driving unit of the electronic device so as to move the second housing part from the extended position to a retracted position based on the obtained first information and second information.

### CROSS-REFERENCE TO RELATED APPLICATION(S)

This application is a continuation application, claiming priority under 35 U.S.C. § 365(c), of an International application No. PCT/KR2024/005093, filed on Apr. 16, 2024, which is based on and claims the benefit of a Korean patent application number 10-2023-0085841, filed on Jul. 3, 2023, in the Korean Intellectual Property Office, and of a Korean patent application number 10-2023-0115580, filed on Aug. 31, 2023, in the Korean Intellectual Property Office, the disclosure of each of which is incorporated by reference herein in its entirety.

### BACKGROUND

### 1. Field

The disclosure relates to a method for controlling a driving unit according to a fall of an electronic device, and an electronic device thereof.

### 2. Description of Related Art

With the advancement of digital technology, various types of electronic devices, such as mobile communication terminals, personal digital assistants (PDAs), electronic organizers, smartphones, tablet personal computers (PCs), or wearable devices, are becoming widely used. These electronic devices are continuously improving their hardware and/or software to support and enhance their functions.

For example, electronic devices are designed so as not to be substantially limited in the size of their displays, or to allow their housings to be moved via a driving unit. These electronic devices may have new form factors, such as multi-display (e.g., a dual display) device (e.g., a foldable electronic device, a rollable devices, or a slidable device). Foldable electronic devices are equipped with a display that is foldable (or bendable) (e.g., a foldable display or a flexible display) and may be used in either a folded or an unfolded state. A rollable device or a slidable device may be equipped with a flexible display, and the flexible display may be rolled up and stored on the back side of the rollable device, or the flexible display may be extended to the front side of the rollable device for use.

The above information is presented as background information only to assist with an understanding of the disclosure. No determination has been made, and no assertion is made, as to whether any of the above might be applicable as prior art with regard to the disclosure.

### SUMMARY

In an embodiment of the disclosure, a method and a device may be disclosed to hardware-connect a grip sensor to a second processor (e.g., a low-power processor) and, when the second processor determines that the electronic device is falling and that a user grip on the electronic device has been released, to selectively call a first processor to operate a driving unit of the electronic device.

Aspects of the disclosure are to address at least the above-mentioned problems and/or disadvantages and to provide at least the advantages described below. Accordingly, an aspect of the disclosure is to provide a method for controlling a driving unit according to a fall of an electronic device, and an electronic device thereof.

Additional aspects will be set forth in part in the description which follows and, in part, will be apparent from the description, or may be learned by practice of the presented embodiments.

In accordance with an aspect of the disclosure, an electronic device is provided. The electronic device includes a housing including a first housing part and a second housing part coupled to be movable relative to the first housing part between an extended position and a retracted position, a first sensor configured to detect movement of the electronic device, a second sensor configured to detect a user grip on the electronic device, a driving unit configured to provide driving force to move the second housing part between the extended position and the retracted position, memory, including one or more storage media, storing instructions, a first processor communicatively coupled to the driving unit and the memory, and a second processor communicatively coupled to the first sensor, the second sensor, and the first processor, wherein the instructions, when executed by the second processor, cause the electronic device to obtain first information related to movement of the electronic device using the first sensor, obtain second information related to a user grip on the electronic device using the second sensor, and request the first processor to operate the driving unit to move the second housing part from the extended position to the retracted position, based on the obtained first and second information, while the second housing part is in the extended position.

In accordance with another aspect of the disclosure, a method for operating an electronic device including a first housing part and a second housing part coupled to be movable relative to the first housing part between an extended position and a retracted position is provided. The method includes obtaining, by a second processor of the electronic device, first information related to movement of the electronic device using a first sensor of the electronic device, obtaining, by the second processor of the electronic device, second information related to a user grip on the electronic device using a second sensor of the electronic device, and requesting, by the second processor, a first processor of the electronic device to operate a driving unit of the electronic device to move the second housing part from the extended position to the retracted position, based on the obtained first and second information, while the second housing part is in the extended position.

In accordance with another aspect of the disclosure, an electronic device is provided. The electronic device includes a housing including a first housing part and a second housing part coupled to be movable relative to the first housing part, a first sensor configured to detect movement of the electronic device, a second sensor configured to detect a user grip on the electronic device, a driving unit configured to provide driving force for movement of the second housing part, memory, including one or more storage media, storing instructions, and at least one processor communicatively coupled to the first sensor, the second sensor, the driving unit, and the memory, wherein the instructions, when executed by the at least one processor individually or collectively, cause the electronic device to obtain a first measurement value related to the movement of the electronic device using the first sensor, obtain a second measurement value related to the user grip on the electronic device using the second sensor, and operate the driving unit to move the second housing part when it is determined that the electronic device is falling and that the user grip has been released based on the obtained first and second measurement values.

According to an embodiment of the disclosure, by hardware-connecting a grip sensor to a second processor and selectively calling the first processor only when the second processor determines that the electronic device has been dropped and that the user grip on the electronic device has been released, the process load and current consumption according to the operation of the first processor can be reduced.

According to an embodiment of the disclosure, since an interrupt signal to operate a motor is transmitted through a specific pin connected between the second processor and the driving unit, a software delay time can be minimized.

According to an embodiment of the disclosure, by securing a software delay time due to changes in the hardware of the electronic device, the motor can be reversely rotated quickly after detecting a drop of the electronic device, thereby minimizing damage to the electronic device.

In accordance with another aspect of the disclosure, one or more non-transitory computer-readable storage media storing one or more computer programs including computer-executable instruction that, when executed by one or more processors of an electronic device individually or collectively, cause the electronic device to perform operations for operating the electronic device including a first housing part and a second housing part coupled to be movable relative to the first housing part between an extended position and a retracted position are provided. The operations including obtaining, by a second processor of the electronic device, first information related to movement of the electronic device using a first sensor of the electronic device, obtaining, by the second processor, second information related to a user grip on the electronic device using a second sensor of the electronic device, and requesting, by the second processor, a first processor of the electronic device to operate a driving unit of the electronic device to move the second housing part from the extended position to the retracted position, based on the obtained first and second information, while the second housing part is in the extended position.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIGS. 2A and 2B are diagrams illustrating front and rear faces of an electronic device in a slide-in state according to various embodiments of the disclosure;

FIGS. 3A and 3B are diagrams illustrating front and rear faces of an electronic device in a slide-out state according to various embodiments of the disclosure;

FIG. 4 is an exploded perspective view of an electronic device according to an embodiment of the disclosure;

FIG. 5A is a cross-sectional view of an electronic device taken along line 5a-5a in FIG. 2A according to an embodiment of the disclosure;

FIG. 5B is a cross-sectional view of an electronic device in an intermediate state according to an embodiment of the disclosure;

FIG. 5C is a cross-sectional view of an electronic device taken along line 5c-5c in FIG. 3A according to an embodiment of the disclosure;

FIG. 6 is a diagram illustrating an internal configuration of an electronic device according to an embodiment of the disclosure;

FIG. 7 is a block diagram illustrating a program module of an electronic device according to an embodiment of the disclosure;

FIG. 8 is a flowchart illustrating an operation method of an electronic device according to an embodiment of the disclosure;

FIG. 9 is a diagram illustrating a possible malfunction in fall detection and grip release recognition in an electronic device according to an embodiment of the disclosure;

FIG. 10 is a flowchart illustrating a method for transmitting an interrupt signal in an electronic device according to an embodiment of the disclosure;

FIG. 11 is a diagram illustrating a hardware connection between a driving unit and a second processor in an electronic device according to an embodiment of the disclosure;

FIG. 12 is a flowchart illustrating a method for monitoring a fall and user grip and transmitting an interrupt signal in an electronic device according to an embodiment of the disclosure; and

FIG. 13 is a flowchart illustrating a method for controlling a driving unit based on a fall and user grip in an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth^{TM} chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

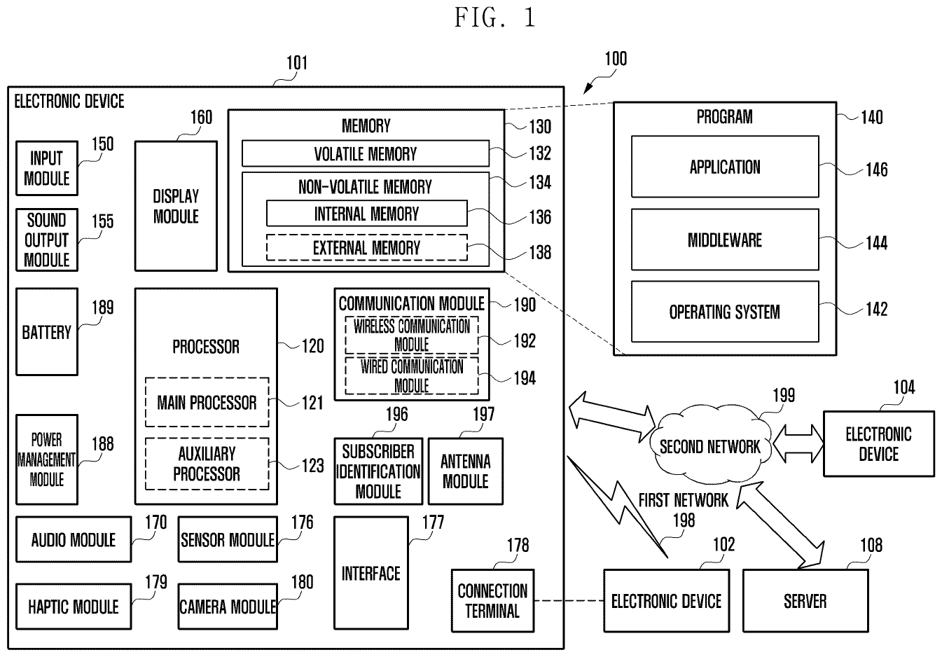

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beamforming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to certain embodiments of the disclosure, the antenna module 197 may form a mmWave antenna module. According to an embodiment of the disclosure, the mmWave antenna module may include a printed circuit board, an RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments disclosed herein may be one of various types of electronic devices. The electronic devices may include, for example, a portable communication device (e.g., a smart phone), a computer device, a portable multimedia device, a portable medical device, a camera, a wearable device, or a home appliance. The electronic device according to embodiments of the disclosure is not limited to those described above.

It should be appreciated that various embodiments of the disclosure and the terms used therein are not intended to limit the technological features set forth herein to particular embodiments and include various changes, equivalents, or alternatives for a corresponding embodiment. With regard to the description of the drawings, similar reference numerals may be used to designate similar or relevant elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “a first”, “a second”, “the first”, and “the second” may be used to simply distinguish a corresponding element from another, and does not limit the elements in other aspect (e.g., importance or order). It is to be understood that if an element (e.g., a first element) is referred to, with or without the term “operatively” or “communicatively”, as “coupled with/to” or “connected with/to” another element (e.g., a second element), it means that the element may be coupled/connected with/to the other element directly (e.g., wiredly), wirelessly, or via a third element.

As used herein, the term “module” may include a unit implemented in hardware, software, or firmware, and may be interchangeably used with other terms, for example, “logic,” “logic block,” “component,” or “circuit”. The “module” may be a minimum unit of a single integrated component adapted to perform one or more functions, or a part thereof. For example, according to an embodiment of the disclosure, the “module” may be implemented in the form of an application-specific integrated circuit (ASIC).

Various embodiments as set forth herein may be implemented as software (e.g., the program 140) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each element (e.g., a module or a program) of the above-described elements may include a single entity or multiple entities, and some of the multiple entities mat be separately disposed in any other element. According to various embodiments of the disclosure, one or more of the above-described elements may be omitted, or one or more other elements may be added. Alternatively or additionally, a plurality of elements (e.g., modules or programs) may be integrated into a single element. In such a case, according to various embodiments of the disclosure, the integrated element may still perform one or more functions of each of the plurality of elements in the same or similar manner as they are performed by a corresponding one of the plurality of elements before the integration. According to various embodiments of the disclosure, operations performed by the module, the program, or another element may be carried out sequentially, in parallel, repeatedly, or heuristically, or one or more of the operations may be executed in a different order or omitted, or one or more other operations may be added.

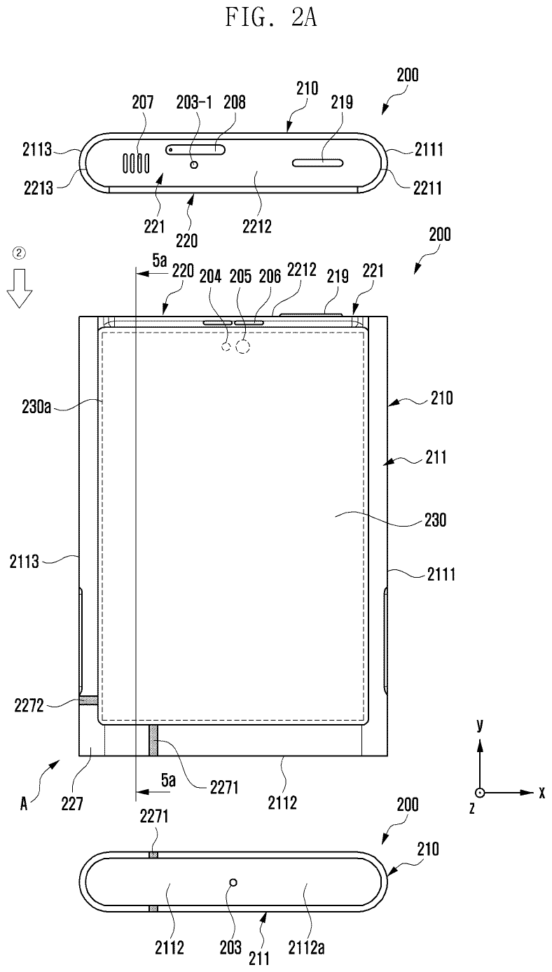

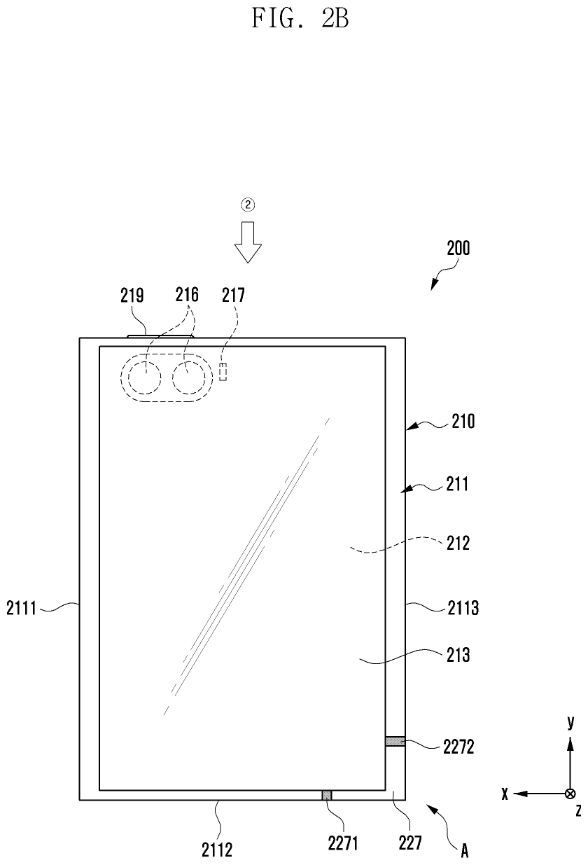

FIGS. 2A and 2B are diagrams illustrating front and rear faces of an electronic device in a slide-in state according to various embodiments of the disclosure.

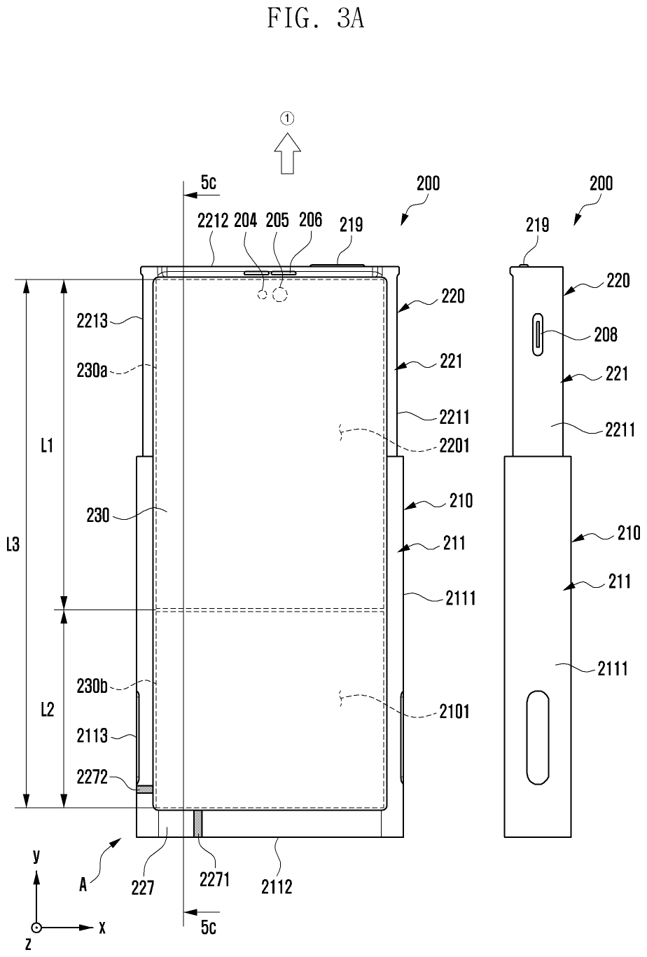

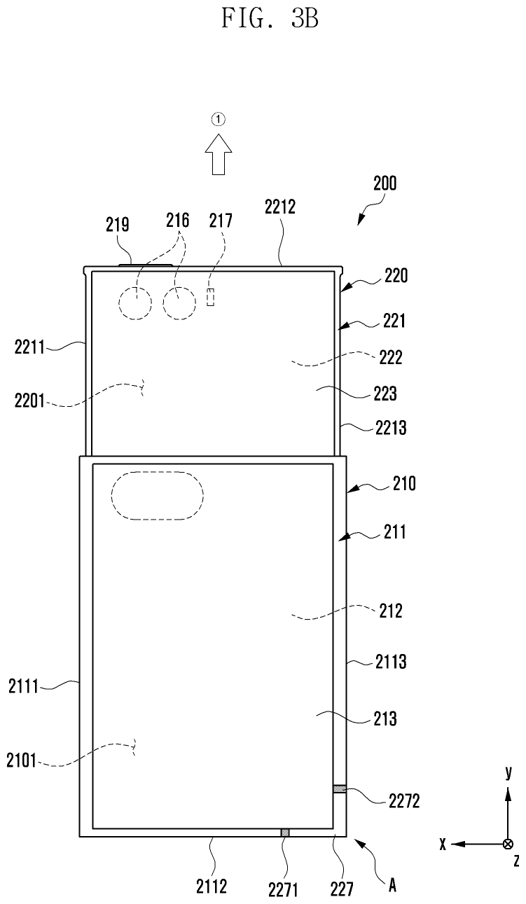

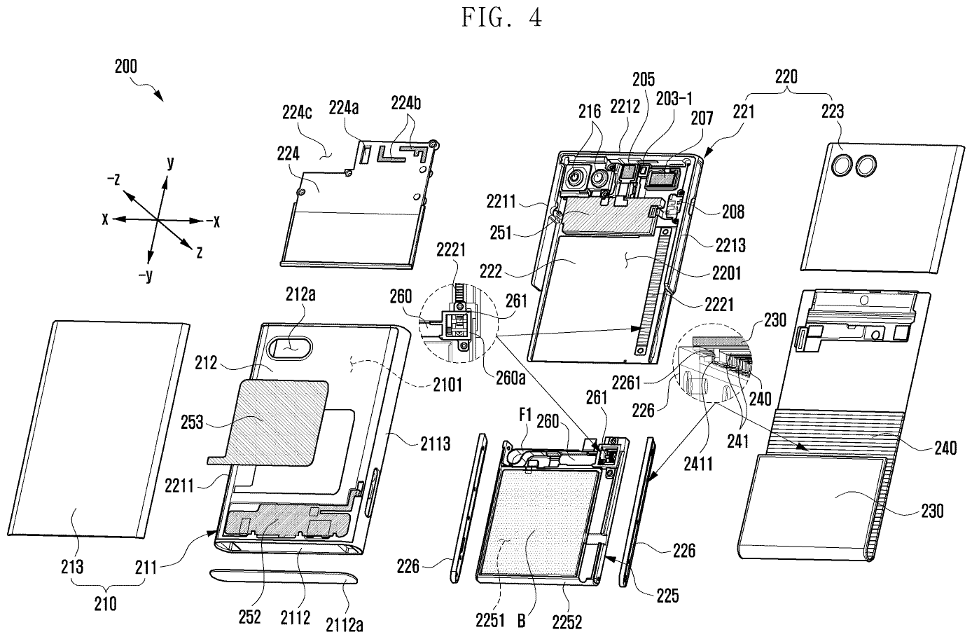

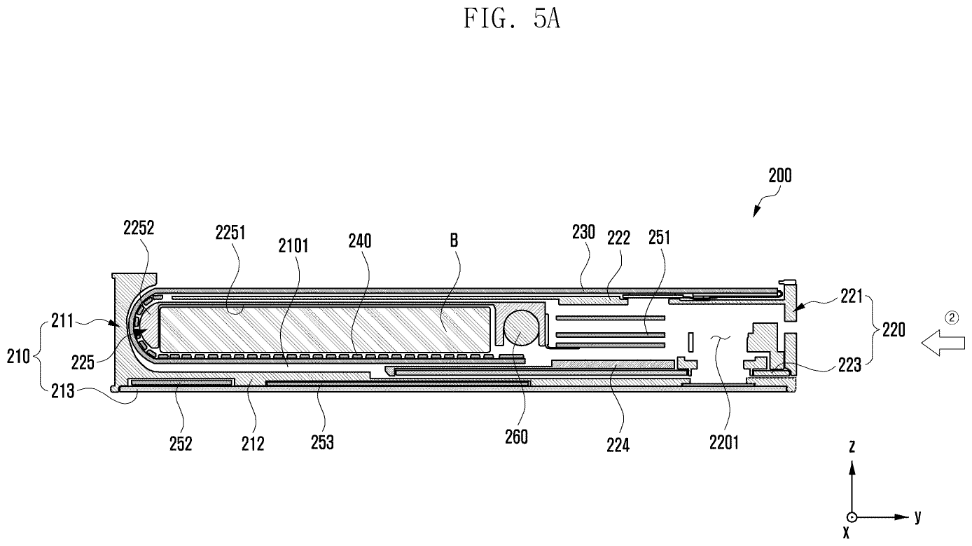

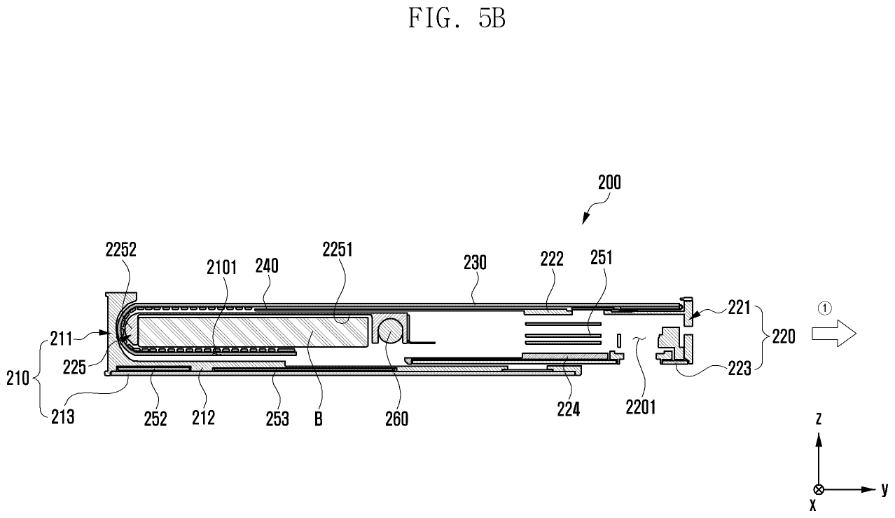

FIGS. 3A and 3B are diagrams illustrating front and rear faces of an electronic device in a slide-out state according to various embodiments of the disclosure.

An electronic device 200 in FIGS. 2A and 3B may be at least partially similar to the electronic device 101 in FIG. 1 or may further include other embodiments of the electronic device.

Referring to FIGS. 2A, 2B, 3A, and 3B, the electronic device 200 may include a first housing 210, a second housing 220 coupled to be slidable from the first housing 210 in a specified direction (e.g., the direction \textcircled{1} or direction \textcircled{2}) (e.g., ±y-axis directions), and a rollable display 230 (e.g., a flexible display, expandable display, or stretchable display) disposed to be supported by at least a portion of the first housing 210 and the second housing 220. In an embodiment of the disclosure, the second housing 220 may be slidably coupled to the first housing 210 so as to slide out in a first direction (direction \textcircled{1}) or slide in in a second direction (direction \textcircled{2}) opposite to the first direction (direction \textcircled{1}) , based on the first housing 210. In an embodiment of the disclosure, the electronic device 200 may switch to a slide-in state (e.g., a retracted state) by accommodating at least a portion of the second housing 220 in at least a portion of a first space 2101 formed by the first housing 210.

In an embodiment of the disclosure, the electronic device 200 may switch to a slide-out state (e.g., an extended state) as at least a portion of the second housing 220 moves outward (e.g., in the direction \textcircled{1}) from the first space 2101. In an embodiment of the disclosure, the electronic device 200 may include a support member (e.g., the support member 240 in FIG. 4) (e.g., a bendable member, a bendable support member, a multi-joint hinge module, or a multi-bar assembly) that forms at least partially the same plane as at least a portion of the second housing 220 in a slide-out state, and is at least partially accommodated into the first space 2101 of the first housing 210 in a bent manner in a slide-in state. In an embodiment of the disclosure, at least a portion of the rollable display 230 may be disposed such that it is attached to at least a portion of the second housing 220.

In an embodiment of the disclosure, at least a portion of the remaining portion of the rollable display 230 may be attached to the support member 240 (e.g., the support member 240 in FIG. 4). In an embodiment of the disclosure, at least a portion of the rollable display 230 may be accommodated in a bent manner within the first space 2101 of the first housing 210 while being supported by the support member (e.g., the support member 240 in FIG. 4) in the slide-in state, so as to be invisible from the outside. In an embodiment of the disclosure, at least a portion of the rollable display 230 may be disposed so as to be visible from the outside while being supported by the support member (e.g., the support member 240 in FIG. 4) that forms at least partially the same plane as the second housing 220 in the slide-out state.

According to various embodiments of the disclosure, the electronic device 200 may include a first housing 210 including a first lateral member 211 and a second housing 220 including a second lateral member 221. In an embodiment of the disclosure, the first lateral member 211 may include a first lateral surface 2111 that has a first length along a first direction (e.g., the y-axis direction), a second lateral surface 2112 that extends from the first lateral surface 2111 in a direction (e.g., the x-axis direction) substantially perpendicular to the first lateral surface 2111 and has a second length shorter than the first length, and a third lateral surface 2113 that extends from the second lateral surface 2112 substantially parallel to the first lateral surface 2111 and has the first length. In an embodiment of the disclosure, the first lateral member 211 may be formed at least partially of a conductive material (e.g., metal). In some embodiments of the disclosure, the first lateral member 211 may be formed by a combination of a conductive material and a non-conductive material (e.g., polymer). In an embodiment of the disclosure, the first housing 210 may include a first extension member 212 extending from at least a portion of the first lateral member 211 to at least a portion of the first space 2101. In an embodiment of the disclosure, the first extension member 212 may be formed integrally with the first lateral member 211. In some embodiments of the disclosure, the first extension member 212 may be formed separately from the first lateral member 211 and then structurally coupled to the first lateral member 211.

According to various embodiments of the disclosure, the second lateral member 221 may include a fourth lateral surface 2211 that corresponds at least partially to the first lateral surface 2111 and has a third length, a fifth lateral surface 2212 that extends from the fourth lateral surface 2211 in a direction substantially parallel to the second lateral surface 2112 and has a fourth length shorter than the third length, and a sixth lateral surface 2213 that extends from the fifth lateral surface 2212 to correspond to the third lateral surface 2113 and has a third length. In an embodiment of the disclosure, the second lateral member 221 may be formed at least partially of a conductive material (e.g., a metal). In some embodiments of the disclosure, the second lateral member 221 may be formed by a combination of a conductive material and a non-conductive material (e.g., a polymer). In an embodiment of the disclosure, at least a portion of the second lateral member 221 may include a second extension member 222 extending to at least a portion of the second space 2201 of the second housing 220. In an embodiment of the disclosure, the second extension member 222 may be formed integrally with the second lateral member 221. In some embodiments of the disclosure, the second extension member 222 may be formed separately from the second lateral member 221 and then structurally coupled to the second lateral member 221.

According to various embodiments of the disclosure, the first lateral surface 2111 and the fourth lateral surface 2211 may be coupled to be slidable relative to each other. In an embodiment of the disclosure, the third lateral surface 2113 and the sixth lateral surface 2213 may be coupled to be slidable relative to each other. In an embodiment of the disclosure, in the slide-in state, the fourth lateral surface 2211 may be disposed to overlap the first lateral surface 2111 and thus be substantially invisible from the outside. In an embodiment of the disclosure, in the slide-in state, the sixth lateral surface 2213 may be disposed to overlap the third lateral surface 2113 and thus be substantially invisible from the outside. In some embodiments of the disclosure, at least a portion of the fourth lateral surface 2211 and the sixth lateral surface 2213 may be disposed to be at least partially visible from the outside in the slide-in state. In an embodiment of the disclosure, in the slide-in state, the second extension member 222 may be disposed to overlap the first extension member 212 and thus be substantially invisible from the outside. In some embodiments of the disclosure, the second extension member 222 may be disposed to be at least partially visible from the outside in the slide-in state.

According to various embodiments of the disclosure, the first housing 210 may include a first rear cover 213 coupled to at least a portion of the first lateral member 211. In an embodiment of the disclosure, the first rear cover 213 may be positioned so as to be coupled to at least a portion of the first extension member 212. In some embodiments of the disclosure, the first rear cover 213 may be formed integrally with the first lateral member 211. In an embodiment of the disclosure, the first rear cover 213 may be formed of polymer, coated or tinted glass, ceramic, metal (e.g., aluminum, stainless steel (STS), or magnesium), or a combination of at least two of these materials. In some embodiments of the disclosure, the first rear cover 213 may extend to at least a portion of the first lateral member 211. In some embodiments of the disclosure, the first rear cover 213 may be omitted, and at least a portion of the first extension member 212 may replace the first rear cover 213.

According to various embodiments of the disclosure, the second housing 220 may include a second rear cover 223 coupled to at least a portion of the second lateral member 221. In an embodiment of the disclosure, the second rear cover 223 may be positioned so as to be coupled to at least a portion of the second extension member 222. In some embodiments of the disclosure, the second rear cover 223 may be formed integrally with the second lateral member 221. In an embodiment of the disclosure, the second rear cover 223 may be formed of polymer, coated or tinted glass, ceramic, metal (e.g., aluminum, stainless steel (STS), or magnesium), or a combination of at least two of these materials. In some embodiments of the disclosure, the second rear cover 223 may extend to at least a portion of the second lateral member 221. In some embodiments of the disclosure, the second rear cover 223 may be omitted, and at least a portion of the second extension member 222 may replace the second rear cover 223.

According to various embodiments of the disclosure, the rollable display 230 may include a first portion 230a (e.g., a flat portion) that is always visible from the outside, and a second portion 230b (e.g., a bendable portion or a bending portion) that extends from the first portion 230a and is accommodated into the first space 2101 of the first housing 210 in an at least partially bent manner so as not to be visible from the outside in the slide-in state. In an embodiment of the disclosure, the first portion 230a may be disposed to be supported by the second housing 220, and the second portion 230b may be disposed to be at least partially supported by the support member (e.g., the support member 240 in FIG. 4). In an embodiment of the disclosure, when the second housing 220 slides out along the first direction (direction \textcircled{1}) , the second portion 230b of the rollable display 230 may be disposed to form substantially the same plane as the first portion 230a while being supported by the support member (e.g., the support member 240 in FIG. 4) and to be visible from the outside. In an embodiment of the disclosure, when the second housing 220 slides in along the second direction (direction \textcircled{2}), the second portion 230b of the rollable display 230 may be accommodated into the first space 2101 of the first housing 210 in a bent manner, and may be disposed so as not to be visible from the outside. Therefore, as the second housing 220 slides along a specified direction (e.g., ±y-axis directions) from the first housing 210, the display area of the rollable display 230 may vary.

According to various embodiments of the disclosure, the length of the rollable display 230 in the first direction (direction \textcircled{1}) may vary as the second housing 220 slides relative to the first housing 210. For example, the rollable display 230, in the slide-in state, may have a first display area corresponding to a first length L1 (e.g., an area corresponding to the first portion 230a). In an embodiment of the disclosure, as the second housing 220 further slides by a second length L2 relative to the first housing 210 in the slide-out state, the rollable display 230 may be expanded to have a second display area (e.g., an area including the first portion 230a and the second portion 230b) that corresponds to a third length L3 greater than the first length L1 and is greater than the first display area.

According to various embodiments of the disclosure, the electronic device 200 may include at least one of an input device (e.g., a microphone 203-1), an audio output device (e.g., a call receiver 206 and/or a speaker 207, sensor modules 204 and 217, a camera module (e.g., a first camera module 205 or a second camera module 216), a connector port 208, a key input device 219, or an indicator (not shown), which are disposed in the second space 2201 of the second housing 220. In an embodiment of the disclosure, the electronic device 200 may include another input device (e.g., a microphone 203) disposed in the first housing 210. In some embodiments of the disclosure, the electronic device 200 may be configured to exclude at least one of the above-described components, or further include other components. In some embodiments of the disclosure, at least one of the above-described components may be positioned in the first space 2101 of the first housing 210.

According to various embodiments of the disclosure, the input device may include a microphone 203-1. In some embodiments of the disclosure, the input device (e.g., the microphone 203-1) may include a plurality of microphones disposed to detect the direction of sound. The audio output device may include, for example, a call receiver 206 and a speaker 207. In an embodiment of the disclosure, the speaker 207 may be exposed to the outside through at least one speaker hole formed in the second housing 220 at a location that is always exposed to the outside (e.g., the fifth lateral surface 2212), regardless of the slide-in/slide-out state. In an embodiment of the disclosure, the connector port 208 may be exposed to the outside through a connector port hole formed in the second housing 220 in the slide-out state. In some embodiments of the disclosure, the connector port 208 may also be exposed to the outside through an opening formed in the first housing 210 so as to correspond to the connector port hole in the slide-in state. In some embodiments of the disclosure, the call receiver 206 may include a speaker (e.g., a piezo speaker) that operates without a separate speaker hole.

According to various embodiments of the disclosure, the sensor modules 204 and 217 may generate electrical signals or data values corresponding to the internal operating state of the electronic device 200 or the external environmental state. In an embodiment of the disclosure, the sensor modules 204 and 217 may include, for example, a first sensor module 204 (e.g., a proximity sensor or an illuminance sensor) positioned on the front face of the electronic device 200 and/or a second sensor module 217 (e.g., a heart rate monitoring (HRM) sensor) positioned on the rear face of the electronic device 200. In an embodiment of the disclosure, the first sensor module 204 may be disposed under the rollable display 230 on the front face of the electronic device 200. In an embodiment of the disclosure, the first sensor module 204 and/or the second sensor module 217 may include at least one of a proximity sensor, an illuminance sensor, a time-of-flight (TOF) sensor, an ultrasonic sensor, a fingerprint recognition sensor, a gesture sensor, a gyro sensor, a barometric pressure sensor, a magnetic sensor, an acceleration sensor, a grip sensor, a color sensor, an infrared (IR) sensor, a biometric sensor, a temperature sensor, or a humidity sensor.

According to various embodiments of the disclosure, the camera module may include a first camera module 205 disposed on the front face of the electronic device 200 and a second camera module 216 disposed on the rear face of the electronic device 200. In an embodiment of the disclosure, the electronic device 200 may also include a flash (not shown) disposed near the second camera module 216. In an embodiment of the disclosure, the camera modules 205 and 216 may include one or more lenses, an image sensor, and/or an image signal processor. In an embodiment of the disclosure, the first camera module 205 may be disposed under the rollable display 230 and configured to capture an object through a portion of the active area (e.g., a display area) of the rollable display 230.

According to various embodiments of the disclosure, the first camera module 205 of the camera modules, and some 204 of the sensor modules 204 and 217 may be disposed to detect the external environment through the rollable display 230. For example, the first camera module 205 or some sensor modules 204 may be disposed in the second space 2201 of the second housing 220 so as to contact the external environment through a transparent area or a perforated opening formed in the rollable display 230. In an embodiment of the disclosure, the area of the rollable display 230 facing the first camera module 205 is a part of an active area for displaying content, and may be formed as a transparent area having a specified transmittance.

In an embodiment of the disclosure, the transparent area may be formed to have a transmittance ranging from about 5% to about 20%. This transparent area may include an area overlapping with the effective area (e.g., the field of view) of the first camera module 205, through which light passes, thereby reaching the image sensor and creating an image. For example, the transparent area of the rollable display 230 may include an area having a lower pixel density and/or lower wiring density than the surrounding area. For example, the transparent area may be replaced with the aforementioned opening. For example, some camera modules 205 may include an under-display camera (UDC). In some embodiments of the disclosure, some sensor modules 204 may be disposed so as not to be visually exposed through the rollable display 230 in the second space 2201 of the second housing 220, thereby perform their functions.

According to various embodiments of the disclosure, the electronic device 200 may include at least one antenna element (e.g., the antenna element 224b in FIG. 4) electrically connected to a wireless communication circuit (e.g., the wireless communication module 192 in FIG. 1) disposed in an internal space (e.g., the second space 2201 of the second housing 220). In an embodiment of the disclosure, the electronic device 200 may also include a bezel antenna A disposed through at least a portion of a conductive first lateral member 211 of the first housing 210. For example, the bezel antenna A may include a conductive portion 227 (e.g., a conductive member) that is disposed through at least a portion of the second lateral surface 2112 and the third lateral surface 2113 of the first lateral member 211 and electrically segmented by at least one segmenting portion 2271 or 2272 formed of a non-conductive material (e.g., polymer).

In an embodiment of the disclosure, a wireless communication circuit (e.g., the wireless communication module 192 in FIG. 1) may be configured to transmit or receive a wireless signal in at least one specified frequency band (e.g., about 600 MHz to 9000 MHz) (e.g., a legacy band or an NR band) through the conductive portion 227. In an embodiment of the disclosure, the electronic device 200 may include a lateral cover 2112a disposed on the second lateral surface 2112 to cover at least a portion of at least one segmenting portion 2271. In some embodiments of the disclosure, the bezel antenna A may be disposed on at least one lateral surface among the first lateral surface 2111, the second lateral surface 2112, or the third lateral surface 2113. In some embodiments of the disclosure, the bezel antenna A may be disposed on at least one lateral surface among the fourth lateral surface 2211, the fifth lateral surface 2212, or the sixth lateral surface 2213 of the second housing 220. In some embodiments of the disclosure, the electronic device 200 may further include at least one antenna module (e.g., a mmWave antenna module or a mmWave antenna structure) that is disposed in an internal space (e.g., the first space 2101 or the second space 2201) and transmits or receives a wireless signal in a frequency band of about 3 GHz to 100 GHz through another wireless communication circuit (e.g., the wireless communication module 192 in FIG. 1).

According to various embodiments of the disclosure, the slide-in/slide-out operation of the electronic device 200 may be performed automatically. For example, the slide-in/slide-out operation of the electronic device 200 may be performed by a driving motor (e.g., the driving motor 260 in FIG. 4) including a pinion gear (e.g., the pinion gear 261 in FIG. 4) disposed in the first space 2101 of the first housing 210, and a rack gear (e.g., a rack gear 2221 in FIG. 4) that is disposed in the second space 2201 of the second housing 220 and engaged with the pinion gear 261. In some embodiments of the disclosure, the driving motor 260 including the pinion gear 261 may be disposed in the second space 2201 of the second housing 220, and the rack gear 2221 engaged with the pinion gear 261 may be disposed in the first space 2101 of the first housing 210.

For example, when the processor (e.g., the processor 120 in FIG. 1) of the electronic device 200 detects a triggering signal for transition from the slide-in state to the slide-out state or from the slide-out state to the slide-in state, the processor may drive the driving motor (e.g., the driving motor 260 in FIG. 4) disposed inside the electronic device 200 may be driven. In an embodiment of the disclosure, the triggering signal may include a signal according to the selection (e.g., touch) for an object displayed on the rollable display 230 or a signal according to the operation for a physical button (e.g., a key button) included in the electronic device 200. In some embodiments of the disclosure, the slide-in/slide-out operation of the electronic device 200 may be manually performed through a user's operation.

According to various embodiments of the disclosure, the electronic device 200 has a structure in which the second housing 220 slides in and/or out relative to the first housing 210 along a longitudinal direction (e.g., vertical direction) (e.g., ±y-axis directions) of the electronic device 200, but the disclosure is not limited thereto. For example, the electronic device 200 may have a structure in which the second housing 220 slides in and/or out relative to the first housing 210 along a width direction (e.g., horizontal direction) (e.g., ±x-axis directions) perpendicular to the longitudinal direction of the electronic device 200. In some embodiments of the disclosure, the electronic device 200 may be configured such that the length of the second lateral surface 2112 of the first housing 210 is greater than the length of the first lateral surface 2111. In this case, the length of the fifth lateral surface 2212 of the second housing 220 may also be formed correspondingly longer than the length of the fourth lateral surface 2211.

FIG. 4 is an exploded perspective view of an electronic device according to an embodiment of the disclosure.

In describing the electronic device 200 in FIG. 4, the same reference numerals are given to components that are substantially the same as those of the electronic device 200 in FIGS. 2A, 2B, 3A, and 3B, and a detailed description thereof will be omitted.

Referring to FIG. 4, the electronic device 200 may include a first housing 210 including a first space 2101, a second housing 220 that is coupled to the housing 210 so as to be slidable relative thereto and includes a second space 2201, a support member 240 that is fixed to at least a portion of the second housing 220 and is at least partially accommodated into the first space 2101 in a bent manner according to a slide-in operation, a rollable display 230 that is disposed to be supported by at least a portion of the support member 240 and the second housing 220, and a drive module (e.g., a drive mechanism) that drives the second housing 220 relative to the first housing 210 in a slide-in direction (e.g., the −y-axis direction) and/or a slide-out direction (e.g., the y-axis direction).

In an embodiment of the disclosure, the first housing 210 may include a first lateral member 211 and a first rear cover 213 coupled to at least a portion of the first lateral member 211 (e.g., at least a portion of the first extension member 212). In an embodiment of the disclosure, the second housing 220 may include a second lateral member 221 and a second rear cover 223 coupled to at least a portion of the second lateral member 221 (e.g., at least a portion of the second extension member 222). In an embodiment of the disclosure, the drive module may include a driving motor 260 disposed in the first space 2101 and including a pinion gear 261, and a rack gear 2221 disposed in the second space 2201 so as to be engaged with the pinion gear 261. In an embodiment of the disclosure, the drive module may further include a reduction module (e.g., a reduction gear assembly) that is connected to the driving motor 260 and is configured to reduce a rotational speed and increase a driving force.

In an embodiment of the disclosure, the driving motor 260 may be disposed to be supported by a motor bracket 260a disposed on a support bracket 225 positioned in the first space 2101 of the first housing 210. In an embodiment of the disclosure, the driving motor 260 may be fixed to an end (e.g., an edge) of the support bracket 225 in the slide-out direction (e.g., the y-axis direction) in the first space 2101. In an embodiment of the disclosure, the rack gear 2221 may be disposed to be fixed to the second extension member 222 of the second housing 220. In some embodiments of the disclosure, the rack gear 2221 may be integrally formed with the second extension member 222 by injection molding to at least a portion thereof. In an embodiment of the disclosure, the rack gear 2221 may be disposed to have a length parallel to the sliding direction (e.g., the ±y-axis directions). Therefore, when the electronic device 200 is assembled, the pinion gear 261 may maintain an engaged state with the rack gear 2221, and the pinion gear 261, which receives the driving force of the driving motor 260, may move along the rack gear 2221, thereby causing the second housing 220 to move relative to the first housing 210. In an embodiment of the disclosure, the sliding distance of the second housing 220 may be determined by the length of the rack gear 2221.

According to various embodiments of the disclosure, the electronic device 200 may include a plurality of electronic components arranged in the second space 2201. In an embodiment of the disclosure, the plurality of electronic components may include a first substrate 251 (e.g., a main substrate), and a camera module 216, a speaker 207, a connector port 208, and a microphone 203-1, which are positioned around the first substrate 251. In an embodiment of the disclosure, since the plurality of electronic components are disposed around the first substrate 251 in the second space 2201 of the first housing 210, efficient electrical connection may be achieved. In some embodiments of the disclosure, at least one of the plurality of electronic components described above may be disposed in the first space 2101 of the first housing 210.

According to various embodiments of the disclosure, the electronic device 200 may include a rear bracket 224 disposed between the second extension member 222 and the second rear cover 223 in the second housing 220. In an embodiment of the disclosure, the rear bracket 224 may be disposed to cover at least some of the plurality of electronic components. In an embodiment of the disclosure, the rear bracket 224 may be structurally coupled to at least a portion of the second extension member 222. In some embodiments of the disclosure, the rear bracket 224 may be omitted. In an embodiment of the disclosure, the rear bracket 224 may be disposed to cover the plurality of electronic components and support the second rear cover 223. In an embodiment of the disclosure, the rear bracket 224 may include an opening 224a (e.g., a through-hole) or a notched region 224c (e.g., a cutout) formed in an area corresponding to the camera module 216 and/or the sensor module (e.g., the sensor module 217 in FIG. 3B). In an embodiment of the disclosure, the rear bracket 224 may include at least one antenna element 224b.

In an embodiment of the disclosure, at least one antenna element 224b may be disposed on the outer surface of the rear bracket 224 when the rear bracket 224 is formed as an injection-molded object of a dielectric material (e.g., an antenna carrier). In an embodiment of the disclosure, at least one antenna element 224b may include a laser-direct structuring (LDS) antenna pattern formed on the outer surface of the rear bracket 224. In some embodiments of the disclosure, at least one antenna element 224b may include a conductive plate attached to the outer surface of the rear bracket 224, a conductive paint formed on the outer surface, or a conductive pattern. In some embodiments of the disclosure, at least one antenna element 224b may be disposed in such a manner that it is embedded in the rear bracket 224 during injection molding. In an embodiment of the disclosure, at least one antenna element 224b may be electrically connected to a wireless communication circuit (e.g., the wireless communication module 192 in FIG. 1) disposed on the first substrate 251, and configured to transmit or receive a wireless signal in a specified frequency band (e.g., a legacy band).

In an embodiment of the disclosure, the camera module 216 and/or the sensor module 217 may be disposed to detect the external environment through the opening 224a or the notched region 224c In an embodiment of the disclosure, the second rear cover 223 may be made transparent in at least an area corresponding to the camera module 216 and/or the sensor module 217. In some embodiments of the disclosure, the second rear cover 223 may include a through-hole formed in at least an area corresponding to the camera module 216 and/or the sensor module 217. In this case, the through-hole may be covered with a transparent window. In some embodiments of the disclosure, the camera module 216 and/or the sensor module 217 may be configured to operate only when the electronic device 200 is in the slide-out state.

According to various embodiments of the disclosure, the electronic device 200 may include a support bracket 225 disposed in the first space 2101 of the first housing 210. In an embodiment of the disclosure, the support bracket 225 may include a support portion 2252 that is disposed at one end and has a curved outer surface to support the rear surface of the support member 240 that bends during a sliding operation for transition from the slide-out state to the slide-in state. In an embodiment of the disclosure, the support bracket 225 may include a support structure for supporting and fixing the driving motor 260 via a motor bracket 260a. In an embodiment of the disclosure, the support bracket 225 may include a battery mounting portion 2251 for accommodating a battery.

In an embodiment of the disclosure, the driving motor 260 may be disposed at the farthest end (e.g., edge) of the support bracket 225 in the slide-out direction (e.g., the y-axis direction). For example, when the assembly of the electronic device 200 is completed, the driving motor 260 may be disposed closest to the first substrate 251 among the electronic components disposed in the first housing 210, thereby contributing to minimizing the size and/or length of a flexible substrate F1 (e.g., a flexible printed circuit board (FPCB)) that electrically connects the first substrate 251 and the driving motor 260. In an embodiment of the disclosure, the electronic device 200 may include a pair of guide rails 226 disposed on both sides of the support bracket 225 to guide both ends of the support member 240 in the sliding direction.

According to various embodiments of the disclosure, the first housing 210 may include an opening 212a (e.g., a through-hole) formed in an area of the first extension member 212 corresponding to the camera module 216 and/or the sensor module 217 disposed in the second housing 220 when the electronic device 200 is in the slide-in state. In an embodiment of the disclosure, the camera module 216 and/or the sensor module 217 may detect the external environment through the opening 212a formed in the first housing 210 when the electronic device 200 is in the slide-in state. In some embodiments of the disclosure, the area of the first rear cover 213 corresponding to the camera module 216 and/or the sensor module 217 may be made transparent.

According to various embodiments of the disclosure, the electronic device 200 may include a second substrate 252 (e.g., a sub-substrate) and an antenna member 253 disposed between the first extension member 212 and the first rear cover 213 in the first housing 210. In an embodiment of the disclosure, the second substrate 252 and the antenna member 253 may be disposed on at least a portion of the first extension member 212. In an embodiment of the disclosure, the second substrate 252 and the antenna member 253 may be electrically connected to the first substrate 251 via at least one electrical connection member (e.g., an FPCB, flexible printed circuit board, or an FRC, flexible RF cable). In an embodiment of the disclosure, the antenna member 253 may include a multi-function coil or multi-function core (MFC) antenna for performing a wireless charging function, a near-field communication (NFC) function, and/or an electronic payment function. In some embodiments of the disclosure, the antenna member 253 may be electrically connected to the second substrate 252, thereby being electrically connected to the first substrate 251 via the second substrate 252. In some embodiments of the disclosure, the second substrate 252 and/or the antenna member 253 may be electrically connected to the first substrate 251 via at least a portion of the flexible substrate F1 connecting the driving motor 260 and the first substrate 251.

According to various embodiments of the disclosure, the support member 240 may be guided by the guide rail 226 during a slide-in/slide-out operation. In an embodiment of the disclosure, the support member 240 may include a plurality of multi-bars 241 rotatably coupled to each other and guide protrusions 2411 protruding from both ends of each of the multi-bars 241. In an embodiment of the disclosure, the guide rail 226 may include a guide slit 2261 formed at a position corresponding to the movement trajectory of the support member 240. In an embodiment of the disclosure, when the support member 240, which is attached and fixed to the back surface of the rollable display 230, is movably coupled to the guide rail 226, the guide protrusion 2411 may move along the guide slit 2611, thereby reducing the phenomenon of the rollable display 230 being detached or deformed during operation.

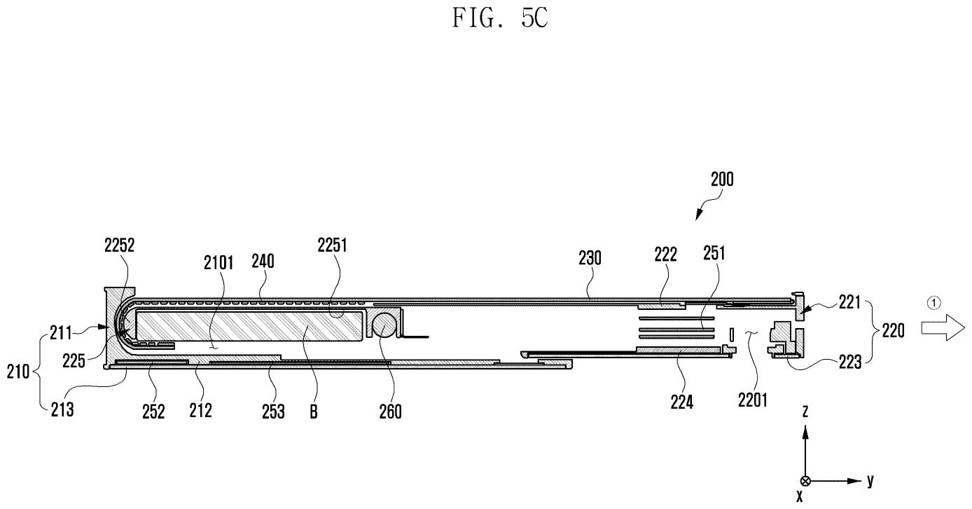

FIG. 5A is a cross-sectional view of an electronic device taken along line 5a-5a in FIG. 2A according to an embodiment of the disclosure.

FIG. 5B is a cross-sectional view of an electronic device in an intermediate state according to an embodiment of the disclosure.

FIG. 5C is a cross-sectional view of an electronic device taken along line 5c-5c in FIG. 3A according to an embodiment of the disclosure.

In describing the electronic device 200 in FIGS. 5A to 5C, the same reference numerals are given to components that are substantially the same as those of the electronic device 200 in FIG. 4, and a detailed description thereof will be omitted.

Referring to FIGS. 5A, 5B, 5C, the electronic device 200 may include a first housing 210 having a first space 2101, a second housing 220 having a second space 2201, a support member 240 connected to the second housing 220 and at least partially accommodated in the first space 2101 in the slide-in state, a rollable display 230 disposed to be supported by at least a portion of the support member 240 and at least a portion of the second housing 220, and a driving motor 260 disposed in the first space 2101 and including a pinion gear (e.g., the pinion gear 261 in FIG. 4) engaged with a rack gear (e.g., the rack gear 2221 in FIG. 4) of the second space 2201. In an embodiment of the disclosure, the driving motor 260 may automatically move the second housing 220 in a slide-in direction (direction \textcircled{2}) or a slide-out direction (direction \textcircled{1}) relative to the first housing 210 through engagement between the pinion gear (e.g., the pinion gear 261 in FIG. 4) and the rack gear 2121 (e.g., the rack gear 2221 in FIG. 4).

According to various embodiments of the disclosure, at least a portion of the second housing 220 may be accommodated in the first space 2101 of the first housing 210 in the slide-in state of the electronic device 200 (the state shown in FIG. 5A). In an embodiment of the disclosure, at least a portion of the rollable display 230 may be accommodated in a bent manner into the first space 2101 along with the support member 240, thereby being disposed so as not to be visible from the outside. In this case, the rollable display 230 may have a first display area (e.g., the display area corresponding to the first portion 230a in FIG. 3A) exposed to the outside.

According to various embodiments of the disclosure, the electronic device 200 may transition from an intermediate state (the state in FIG. 5B) to a slide-out state (the state in FIG. 5C) by controlling the operation of the driving motor 260. In some embodiments of the disclosure, the electronic device 200 may be configured to stop in a specified intermediate state between the slide-in state and the slide-out state (e.g., a free stop function). In some embodiments of the disclosure, the electronic device 200 may transition to the slide-in state, the intermediate state, or the slide-out state through a user's manipulation when no driving force is provided to the driving motor 260.

In some embodiments of the disclosure, when the electronic device 200 detects a user's operation of applying force in a certain direction through a user's manipulation to switch to the slide-in state, the intermediate state, or the slide-out state without driving the driving motor 260, the electronic device 200 may operate the driving motor 260 to assist the user in performing the switching to an intended state. For example, when the user attempts to manually move the first housing 210 or the second housing 220 to perform a slide-in operation, the electronic device 200 may detect this and operate the driving motor 260 to assist the corresponding operation.

According to various embodiments of the disclosure, at least a portion of the second housing 220 may transition to a slide-out state in which the second housing 220 is at least partially moved outward from the first housing 210 in the first direction (direction \textcircled{1}) by driving the driving motor 260. In an embodiment of the disclosure, the rollable display 230 may move, along with the support member 240, while being supported by the support bracket 225 in the slide-out state of the electronic device 200 (the state in FIG. 5C) so that a portion slid into the first space 2101 may be exposed so as to be at least partially visible from the outside. In this case, the rollable display 230 may have a second display area (e.g., a display area including the first portion 230a and the second portion 230b in FIG. 3A) expanded beyond the first display area and exposed to the outside.

According to various embodiments of the disclosure, the electronic device 200 may include a battery B disposed through a battery mounting portion 2251 of the support bracket 225 fixed to the first space 2101 of the first housing 210. In an embodiment of the disclosure, since the battery B is disposed in the first housing 210, a separate driving gap may not be required to avoid interference with surrounding structures due to movement. Therefore, the battery B may have a thickness such that it approaches or contacts the rear surface of the support member 240 from the battery mounting portion 2251 of the support bracket 225, so that the battery volume may relatively increase and the moving support member 240 may be supported, thereby reducing sagging of the rollable display 230 and contributing to improved operational reliability.

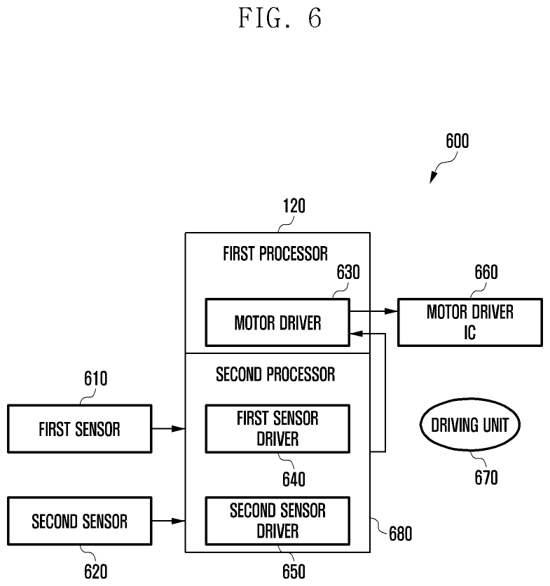

FIG. 6 is a diagram illustrating an internal configuration of an electronic device according to an embodiment of the disclosure.

Referring to FIG. 6, an electronic device (e.g., the electronic device 101 in FIG. 1) according to an embodiment may include a first sensor 610, a second sensor 620, a first processor (e.g., the processor 120 in FIG. 1), a motor driver 630, a second processor 680 (e.g., the auxiliary processor 123 in FIG. 1), a first sensor driver 640, a second sensor driver 650, a motor driver integrated circuit (IC) 660, and a driving unit 670. The first processor 120 and the second processor 680 may be incorporated or integrated into a single system-on-chip.

The first sensor 610 (e.g., the sensor module 176 in FIG. 1) may be a sensor for detecting (or sensing) the movement of the electronic device 101. For example, the first sensor 610 may refer to an acceleration sensor, a gyro sensor, or a 6-axis sensor. The first sensor 610 may detect the movement of the electronic device 101 and transmit measured first information (or measurement value, sensed value, or sensor data) to the second processor 680.

The second sensor 620 (e.g., the sensor module 176 in FIG. 1) may be a sensor for detecting (or sensing) a user grip on the electronic device 101. Here, the user grip may refer to a user's action of holding the electronic device 101. For example, the second sensor 620 may refer to a grip sensor, a contact detection sensor, or a grip detection sensor. The second sensor 620 may transmit second information (or measurement value, sensing value, or sensor data) obtained by detecting a user grip on the electronic device 101 to the second processor 680.

The first processor 120 may refer to a main processor (e.g., the main processor 121 in FIG. 1). The first processor 120 may be an application processor. The first processor 120 may control at least one other component (e.g., hardware or software component) of the electronic device 101 and perform various data processing or calculations. The first processor 120 may be integrated with the second processor 680 and logically separated from it, or may be physically separated from the second processor 680. According to an embodiment of the disclosure, the first sensor 610 or the second sensor 620 may directly transmit the obtained information to the first processor 120 without the second processor 680. For example, the first sensor 610 may directly transmit movement information of the electronic device 101 to the first processor 120 via the first sensor driver 640.

The second processor 680 may refer to a low-power processor (e.g., the auxiliary processor 123 in FIG. 1). The second processor 680 may be configured to use lower power than the first processor 120 or to be specialized for a specific function. The second processor 680 may control at least some of functions or states related to at least one of the components of the electronic device 101 on behalf of the first processor 120 while the first processor 120 is in an inactive (e.g., sleep) state. Alternatively, the second processor 680 may control at least some of functions or states related to at least one of the components of the electronic device 101 together with the first processor 120 while the first processor 120 is in an active (e.g., application execution) state.

The second processor 680 may include a first sensor driver 640 and a second sensor driver 650. The first sensor driver 640 may be an interface module connected to the first sensor 610 and configured to control a first sensor controller connected to the first sensor 610. The second sensor driver 650 may be an interface module connected to the second sensor 620 and configured to control a second sensor controller connected to the second sensor 620. The second processor 680 may obtain, through the first sensor driver 640, first information (or measurement value) related to the movement of the electronic device 101, which is measured by the first sensor 610. The second processor 680 may determine whether the electronic device 101 is falling, based on the first information. The second processor 680 may obtain, through the second sensor driver 650, second information (or measurement value) related to the user grip on the electronic device 101 measured by the second sensor 620. The second processor 680 may determine whether the user grip of the electronic device 101 has been released based on the second information.

According to an embodiment of the disclosure, the first processor 120 may be referred to as a high-power processor, a high-performance processor, or a main processor, and the second processor 680 may be referred to as a sub-processor, an auxiliary processor, a low-power processor, a low-performance processor, a sensor hub, or a sensor processor. The first processor 120 of the electronic device 101 may control functions or operations related to the first sensor 610 and the second sensor 620 by activating only the area (or block) allocated to the second processor 680 within the first processor 120. The second processor 680 may be implemented as part of the first processor 120 (e.g., as a single chip). The second processor 680 may be placed in a logically separate portion within the first processor 120, and the first processor 120 and the second processor 680 may be integrated into a single chip.

According to an embodiment of the disclosure, while a second housing part included in the electronic device 101 is in an extended position, the second processor 680 may request, based on the obtained first information and second information, the first processor 120 to operate the driving unit to move the second housing part from the extended position to a retracted position. The extended position may include at least one of a slide-out state, a motor-driven state, a rollable-out state, an electronic device-opened state, and/or a camera lens-driven state. For example, the electronic device 101 may include a first housing part (e.g., the first housing 210 in FIGS. 2A, 2B, 3A, and 3B) and a second housing part (e.g., the second housing 220 in FIGS. 2A, 2B, 3A, and 3B) coupled to be movable relative to the first housing part between the extended position and the retracted position. The retracted position may be a state in which the second housing 220 is fully accommodated within the first housing 210, and the extended position may be a state in which at least a portion of the second housing 220 has moved outside of the first housing 210. The extended position may include a state in which the second housing 220 is completely or partially (e.g., an intermediate state) slid out from the first housing 210.

According to an embodiment of the disclosure, while the second housing 220 is in the extended position, the second processor 680 may request the first processor 120 to operate the driving unit 670 to move the second housing part from the extended position to the retracted position, based on first information indicating that the user grip, as the second information, has been released from the electronic device 101 and that the electronic device 101 is falling. The first processor 120 may be an application processor, and the second processor 680 may consume less power than the first processor 120. The first processor 120 and the second processor 680 may be incorporated or integrated into a single system-on-chip.

According to an embodiment of the disclosure, when the second processor 680 determines that the electronic device 101 is falling (or detects or predicts a fall) based on the first information, the second processor 680 may determine whether the user grip on the electronic device 101 has been released based on the second information. According to an embodiment of the disclosure, the second processor 680 may simultaneously or sequentially determine the fall of the electronic device 101 and the release of the user grip on the electronic device 101. According to an embodiment of the disclosure, the second processor 680 may sequentially determine whether the user grip on the electronic device 101 has been released and whether the electronic device 101 is falling. The second processor 680 may determine whether the user grip on the electronic device 101 has been released within a specified time after detecting a fall of the electronic device 101. The specified time may be configured as a default value for the electronic device 101 or may be changed based on user input.

According to an embodiment of the disclosure, when the second processor 680 determines that the electronic device 101 is falling and/or that the user grip on the electronic device 101 has been released, the second processor 680 may call the first processor 120 to operate the driving unit 670. The second processor 680 may transmit an interrupt signal to the first processor 120 to operate the driving unit 670. According to an embodiment of the disclosure, the second processor 680 may establish an electrical path with a motor driver 630 included in the first processor 120. The second processor 680 may directly transmit an interrupt signal to the motor driver 630. The interrupt signal may be transmitted from the second processor 680 to the motor driver 630 through an interface (or pin) through which the second processor 680 and the motor driver 630 are directly connected in hardware.

According to an embodiment of the disclosure, when at least one piece of information sensed by the first sensor 610 and the second sensor 620 has a value greater than or equal to a reference value indicating a fall and/or release of the grip on the electronic device 101, the second processor 680 may directly apply a signal to the driving unit 670 to operate the driving unit 670. For example, in order to reduce the delay time of applying the driving unit through another processor, the driving unit 670 may be directly operated by at least one component among the first sensor 610, the second sensor 620, the first sensor driver 640, the second sensor driver 650, the second processor 680, and the first processor 120.

According to an embodiment of the disclosure, the second processor 680 may obtain third information related to the movement of the electronic device 101 in the state of a first fall of the electronic device 101 and a release of the user grip on the electronic device 101. The third information may be a value obtained after the first information. “First,” “second,” and “third” may be used to distinguish different pieces of information. According to an embodiment of the disclosure, when it is determined that the electronic device 101 is falling and that the user grip on the electronic device 101 has been released, the second processor 680 may make a second determination (or final determination) as to whether the electronic device 101 is falling. For example, the second processor 680 may make a second determination as to whether the electronic device 101 is falling after a specified time from the first fall of the electronic device 101 and the release of the user grip on the electronic device 101.

According to an embodiment of the disclosure, the specified time may be configured to identify a fall malfunction rather than a fall of the electronic device 101. For example, the user may perform an action (or operation) of intentionally dropping the electronic device 101 and re-grasping it. When it is determined that the electronic device 101 is falling while the user grip on the electronic device 101 remains released even after the specified time, the second processor 680 may determine that the electronic device 101 is actually falling, not a fall malfunction. The second processor 680 may determine whether the electronic device 101 is in a final falling state, based on the obtained third information.

According to an embodiment of the disclosure, when the electronic device 101 is determined to be in a final falling state, the second processor 680 may call the first processor 120 to operate the driving unit 670. When the user grip on the electronic device 101 is not released, the second processor 680 may determine it to be a fall malfunction. When the fall malfunction is determined, the second processor 680 may not call the first processor 120. Alternatively, when the electronic device 101 is determined not to be in a final falling state, the second processor 680 may not call the first processor 120.

According to an embodiment of the disclosure, the motor driver 630 may operate the driving unit 670 through the motor driver IC 660. When the motor driver 630 receives an interrupt signal, it may operate the driving unit 670 through the motor driver IC 660. The motor driver 630 may transmit, to the driving unit 670, a motor drive command to operate the driving unit 670. Although the drawing illustrates that the motor driver 630 is included in the first processor 120, the motor driver 630 may exist outside the first processor 120. According to an embodiment of the disclosure, the motor driver 630 may be included in a part (e.g., a kernel) of a software module. To operate the motor driver 630, the first processor 120 may be woken up from a sleep or inactive state. This may include a transition of the first processor 120 from a state in which it does not perform at least some processing or in which a requested resource is not immediately available to a state in which it performs at least some processing or in which a requested resource is available on standby. The first processor 120 may wake up upon a call from the second processor 680 and transmit a motor drive command to the motor driver 630 to operate the driving unit 670. Alternatively, the entire first processor 120 may not wake up, but only a part of the kernel including the motor driver 630 may wake up and transmit a motor drive command to operate the driving unit 670.

According to an embodiment of the disclosure, the driving unit 670 may provide driving force for movement of a housing part included in the electronic device 101. For example, in the case where the electronic device 101 includes a housing including a first housing part (e.g., the first housing 210 in FIGS. 2A, 2B, 3A, and 3B), and a second housing part (e.g., the second housing 220 in FIGS. 2A, 2B, 3A, and 3B) that is coupled to the first housing part so as to be movable relative thereto, the driving unit 670 may provide a driving force to move the second housing 220.

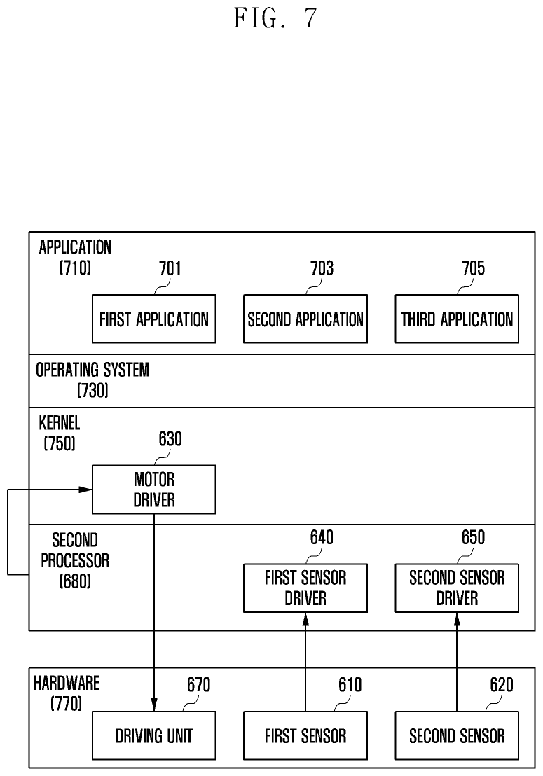

FIG. 7 is a block diagram illustrating a program module of an electronic device according to an embodiment of the disclosure.

Referring to FIG. 7, an electronic device (e.g., the electronic device 101 in FIG. 1) according to an embodiment may include a program module that includes an operating system (OS) (e.g., the operating system 142 in FIG. 1) for controlling resources related to the electronic device 101 and/or various applications running on the operating system.

The program module may include applications 710, an operating system 730, a kernel 750, and a second processor 680. At least a part of the program module may be preloaded on the electronic device 101 or downloaded from an external electronic device (e.g., the external electronic device 102 or 104 or the server 106). The applications 710 may include at least one application (e.g., a first application 701, a second application 703, and a third application 705) that is stored in memory (e.g., the memory 130 in FIG. 1) of the electronic device 101 and executable by a processor (e.g., the processor 120 in FIG. 1). The applications 710 may not be limited in type, such as a camera, an Internet browser, a video, or a game application. Alternatively, the application 710 may refer to an application that constitutes several GUI (graphical user interface) screens implemented on the system of the electronic device 101, such as a notification bar or quick view.

The operating system 730 may control the management (e.g., allocation or recovery) of one or more system resources (e.g., processes, memories, or power sources) of the electronic device 101. For example, the operating system 730 may be an operating system, such as Android, iOS, Windows, Symbian, Tizen, or Bada. FIG. 7 may illustrate a program module operating in an electronic device 101 of an Android operating system. The operating system 730 may additionally or alternatively include one or more driver programs for driving other hardware devices (e.g., the input module 150, the sound output module 155, or the like) of the electronic device 101.

According to an embodiment of the disclosure, the kernel 750 may include various drivers for controlling various hardware modules included in the electronic device 101. The kernel 750 may include a motor driver 630. The motor driver 630 may be an interface module connected to the driving unit 670 and controlling the driving unit 670. When the motor driver 630 receives a motor drive command from a first processor (e.g., the processor 120 in FIG. 1), it may transmit a command to the motor driver IC for reverse rotation at the maximum possible speed. Although not shown, the kernel 750 may further include another driver (e.g., a display driver integrated circuit (DDI) controller).

According to an embodiment of the disclosure, the second processor 680 may include various drivers for controlling various hardware modules included in the electronic device 101. It may include a first sensor driver 640 and a second sensor driver 650. The first sensor driver 640 may be an interface module connected to the first sensor 610 and controlling the first sensor 610. The second sensor driver 650 may be an interface module connected to the second sensor 620 and controlling the second sensor 620.

According to an embodiment of the disclosure, the hardware 770 may include a driving unit 670, a first sensor 610, or a second sensor 620. In the case where the electronic device 101 includes a housing including a first housing part (e.g., the first housing 210 in FIGS. 2A, 2B, 3A, and 3B), and a second housing part (e.g., the second housing 220 in FIGS. 2A, 2B, 3A, and 3B) that is coupled to the first housing part so as to be movable relative thereto, the driving unit 670 may provide a driving force to move the second housing 220 from the first housing 210. The driving unit 670 may operate by a voltage supplied from a motor driver IC. According to an embodiment of the disclosure, the first sensor 610 may detect the movement of the electronic device 101. According to an embodiment of the disclosure, the second sensor 620 may detect a user grip on the electronic device 101.

The sensor for detecting the user's movement or grip is not limited to the first sensor 610 or the second sensor 620, and the second processor 680 may detect the user's movement or grip by combining values obtained from a plurality of other sensors not shown. For example, the user grip may be detected using a proximity sensor and a camera sensor, or the movement of the electronic device 101 may be detected through a combination of measurement values obtained using an acceleration sensor, a gyro sensor, and a proximity sensor. Through this, the movement of the device may be determined more accurately.

An electronic device 101 according to an embodiment of the disclosure may include a housing including a first housing part 210 and a second housing 220 coupled to be movable relative to the first housing part between an extended position and a retracted position, a first sensor 610 configured to detect movement of the electronic device, a second sensor 620 configured to detect a user grip on the electronic device, a driving unit 670 configured to provide driving force to move the second housing part between the extended position and the retracted position, memory 130, a first processor 120 operatively connected to the driving unit and the memory, and a second processor 680 operatively connected to the first sensor, the second sensor, and the first processor. The second processor may obtain first information related to movement of the electronic device using the first sensor, obtain second information related to a user grip on the electronic device using the second sensor, and request the first processor to operate the driving unit to move the second housing part from the extended position to the retracted position, based on the obtained first and second information, while the second housing part is in the extended position.

The second processor may request the first processor to operate the driving unit to move the second housing part from the extended position to the retracted position, based on the first information indicating that the electronic device is falling in a state in which the user grip has been released from the electronic device based on the second information, while the second housing part is in the extended position.

The first processor may be an application processor, and the second processor may be a processor that consumes less power than the first processor.

The first processor and the second processor may be incorporated or integrated into a single system-on-chip.

The retracted position may be a state in which the second housing part is substantially completely accommodated within the first housing part, and the extended position may be a state in which at least a portion of the second housing part has moved outside of the first housing part.

The second processor may obtain second information related to the user grip on the electronic device within a specified time according to the obtained first information, obtain third information related to the movement of the electronic device after the specified time in a state in which the user grip on the electronic device has been released based on the obtained second information, and request the first processor to operate the driving unit when it is determined that the electronic device is falling based on the obtained third information.

The second processor may obtain second information related to the user grip on the electronic device within a specified time according to the obtained first information and, when the user grip on the electronic device has not been released based on the obtained second information, determine that the electronic device is not actually falling, thereby not requesting the first processor to operate the driving unit.

An electronic device 101 according to an embodiment of the disclosure may include a housing including a first housing part 210 and a second housing 220 coupled to be movable relative to the first housing part, a first sensor 610 configured to detect movement of the electronic device, a second sensor 620 configured to detect a user grip on the electronic device, a driving unit 670 configured to provide driving force for movement of the second housing part, memory 130, and processor operatively connected to the first sensor, the second sensor, the driving unit, and the memory, wherein the processor may obtain a first measurement value related to the movement of the electronic device using the first sensor, obtain a second measurement value related to the user grip on the electronic device using the second sensor, and operate the driving unit to move the second housing part when it is determined that the electronic device is falling and that the user grip has been released based on the obtained first and second measurement values.

The processor may include a first processor or a second processor, and the first processor or the second processor may be configured to operate the driving unit.

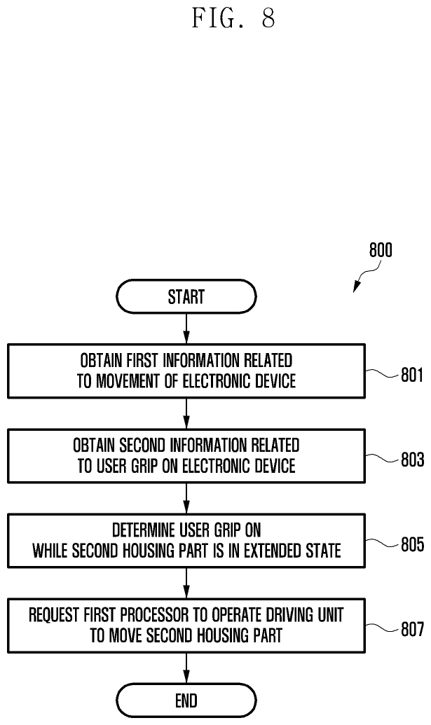

FIG. 8 is a flowchart 800 illustrating an operation method of an electronic device according to an embodiment of the disclosure.

Referring to FIG. 8, in operation 801, a processor (e.g., the auxiliary processor 123 in FIG. 1 or the second processor 680 in FIG. 6) of an electronic device (e.g., the electronic device 101 in FIG. 1) according to an embodiment may obtain first information (or a measurement value) related to the movement of the electronic device 101. According to an embodiment of the disclosure, the second processor 680 may obtain first information (or sensing value or sensor data) from a first sensor (e.g., the first sensor 610 in FIG. 6). The first sensor 610 may refer to an acceleration sensor, a gyro sensor, or a 6-axis sensor. The first sensor 610 may detect the movement of the electronic device 101 and transmit measured first information to the second processor 680. Alternatively, the second processor 680 may read the measured first information from the first sensor 610. The second processor 680 may detect the movement of the electronic device 101 by further using measurement values of a plurality of sensors, in addition to the first sensor 610.

Although the disclosure will be illustrated below as being performed by the second processor 680, the disclosure may also be performed by a first processor (e.g., the processor 120 in FIG. 1). According to an embodiment of the disclosure, the first processor 120 and the second processor 680 may be incorporated or integrated into a single system-on-chip (SoC). For example, the second processor 680 may be added to the first processor 120 as a software function module (or block), thereby performing the disclosure.

In operation 803, the second processor 680 may obtain second information (or a measurement value) related to a user grip on the electronic device 101. The second processor 680 may obtain second information (or sensing value or sensor data) from a second sensor (e.g., the second sensor 620 in FIG. 6). Here, the user grip may refer to a user's action of holding the electronic device 101. For example, the second sensor 620 may refer to a grip sensor, a contact detection sensor, or a grip detection sensor. The second sensor 620 may transmit the second measurement value obtained by detecting the user grip on the electronic device 101 to the second processor 680. Alternatively, the second processor 680 may read the second measurement value measured by the second sensor 620. The second processor 680 may detect the user grip on the electronic device 101 by further using measurement values of a plurality of sensors, in addition to the second sensor 660.

Although the drawing illustrates that operation 803 is performed after operation 801, operations 801 and 803 may be performed simultaneously. Alternatively, operation 803 may be performed first, followed by operation 801. The disclosure is not limited to the drawing.

In operation 805, the second processor 680 may determine the grip on the electronic device 101 while the second housing part (e.g., the second housing 220 in FIGS. 2A, 2B, 3A, and 3B) is in an extended state (e.g., an extended position). For example, the second processor 680 may determine whether the electronic device 101 is falling based on the first information. The second processor 680 may determine whether the user grip on the electronic device 101 has been released based on the second information. According to an embodiment of the disclosure, the second processor 680 may perform grip sensing by detecting a change in the capacitance component generated through a part of the user's body that is in contact with the second sensor 620. The second processor 680 may identify the capacitance values, identify a change in the capacitance values according to the case where the user does not grip the electronic device 10, and, when the change exceeds a certain reference value, determine that the user is no longer gripping the electronic device 101 and it is in a grip release state. According to an embodiment of the disclosure, the grip sensor may use a proximity sensor to determine a grip release state when a part of the user's body moves away from the electronic device 101.

According to an embodiment of the disclosure, while the second housing part included in the electronic device 101 is in the extended position, the second processor 680 may determine whether the electronic device 101 is falling and whether the user grip on the electronic device 101 has been released. The extended position (or a specified state) may include at least one of a slide-out state, a motor-driven state, a rollable-out state, an electronic device-opened state, and/or a camera lens-driven state. For example, the electronic device 101 may include a housing including a first housing part (e.g., the first housing 210 in FIGS. 2A, 2B, 3A, and 3B) and a second housing part (e.g., the second housing 220 in FIGS. 2A, 2B, 3A, and 3B) coupled to be movable relative to the first housing part between an extended position and a retracted position. The retracted position may be a state in which the second housing 220 is completely accommodated within the first housing 210, and the extended position may be a state in which at least a portion of the second housing 220 has moved outside of the first housing 210. The extended position may include a state in which the second housing 220 is completely or partially (e.g., an intermediate state) slid out from the first housing 210.

When the second processor 680 makes a first determination that the electronic device 101 is falling (or a fall is detected or predicted) based on the first information, the second processor 680 may determine whether the user grip on the electronic device 101 has been released based on the second information. The second processor 680 may simultaneously or sequentially determine the fall of the electronic device 101 and the release of the user grip on the electronic device 101. The second processor 680 may determine whether the user grip on the electronic device 101 has been released within a specified time after detecting a fall of the electronic device 101.

In operation 807, the second processor 680 may request the first processor 120 to operate a driving unit (e.g., the driving unit 670 in FIG. 6) to move the second housing 220 (or the second housing part). When it is determined that the electronic device 101 is falling and that the user grip on the electronic device 101 has been released, the second processor 680 may call the first processor 120 to operate the driving unit 670. The second processor 680 may transmit an interrupt signal to the first processor 120 to operate the driving unit 670. The second processor 680 may form an electrical path with a motor driver (e.g., the motor driver 630 in FIG. 6) included in the first processor 120. The second processor 680 may directly transmit an interrupt signal to the motor driver 630. The interrupt signal may be transmitted from the second processor 680 to the motor driver 630 through an interface (or pin) through which the second processor 680 and the motor driver 630 are directly connected in hardware.

According to an embodiment of the disclosure, the motor driver 630 may transmit a motor drive command to the driving unit 670 to operate the driving unit 670. The motor driver 630 may be included in a part (e.g., a kernel (e.g., the kernel 750 in FIG. 7)) of a software module. To drive the motor driver 630, when the first processor 120 is in a sleep state, the first processor 120 may be woken up. The first processor 120 may be woken up upon a call from the second processor 680 and may transmit a motor drive command to the motor driver 630 to operate the driving unit 670. Alternatively, instead of waking up the entire first processor 120, only a part of the kernel including the motor driver 630 may be woken up to transmit a motor drive command to operate the driving unit 670. According to an embodiment of the disclosure, when the first processor 120 does not include the motor driver 630, the motor driver 630 may directly transmit a motor drive command to operate the driving unit 670.

For example, the motor driver 630 may transmit, to the motor driver IC, a command to perform a reverse rotation at the maximum possible speed. The driving unit 670 may move (e.g., reverse-rotate) the second housing 220 according to the command transmitted to the motor driver IC. According to an embodiment of the disclosure, when the electronic device (e.g., the second processor 680) detects a fall of the electronic device while the second housing 220 is in a moved or moving state, it may quickly rotate the driving unit 670 in reverse, thereby minimizing damage to the electronic device 101.

According to an embodiment of the disclosure, the second processor 680 may obtain third information (or a measurement value) related to the movement of the electronic device 101 in the state of a first fall of the electronic device 101 and a release of the user grip on the electronic device 101. The third information may be a value obtained after the first information. According to an embodiment of the disclosure, the measurement values are not necessarily sequential, and the third measurement value may be measured first, or the third measurement value and the first measurement value may be measured at least partially simultaneously. When it is determined that the electronic device 101 is falling and that the user grip on the electronic device 101 has been released, the second processor 680 may make a second determination (or final determination) as to whether the electronic device 101 is falling. For example, the second processor 680 may make a second determination as to whether the electronic device 101 is falling after a specified time from the first fall of the electronic device 101 and the release of the user grip on the electronic device 101. The specified time may be configured to identify a fall malfunction rather than a fall of the electronic device 101. For example, the user may perform an action (or operation) of intentionally dropping the electronic device 101 and re-grasping it. When it is determined that the electronic device 101 is falling while the user grip on the electronic device 101 remains released even after the specified time, the second processor 680 may determine that the electronic device 101 is actually falling, not a fall malfunction. The second processor 680 may determine whether the electronic device 101 is in a final falling state, based on the obtained third measurement value.

When the electronic device 101 is determined to be in a final falling state, the second processor 680 may call the first processor 120 to operate the driving unit 670. When the user grip on the electronic device 101 is not released, the second processor 680 may determine it to be a fall malfunction. When the fall malfunction is determined, the second processor 680 may not call the first processor 120. Alternatively, when the electronic device 101 is determined not to be in a final falling state, the second processor 680 may not call the first processor 120.

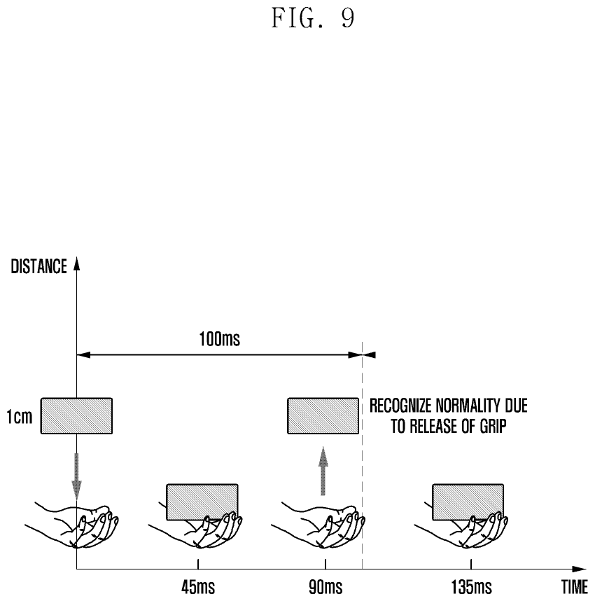

FIG. 9 is a diagram illustrating a possible malfunction in fall detection and grip release recognition in an electronic device according to an embodiment of the disclosure.

Referring to FIG. 9, a processor (e.g., the auxiliary processor 123 in FIG. 1 or the second processor 680 in FIG. 6) of an electronic device (e.g., the electronic device 101 in FIG. 1) according to an embodiment of the disclosure, when it is determined that the electronic device 101 is falling based on first information (or a measurement value) measured by a first sensor (e.g., the first sensor 610 in FIG. 6), may determine (or detect) whether a user grip on the electronic device 101 has been released based on second information (or a measurement value) measured by a second sensor (e.g., the second sensor 620 in FIG. 6). Hereinafter, although the description will be made regarding the second processor 680 determining whether the electronic device 101 is falling or the grip on the electronic device 101 has been released, the first processor (e.g., the processor 120 in FIG. 1) may also determine whether the electronic device 101 is falling or the grip on the electronic device 101 has been released. According to an embodiment of the disclosure, the first processor 120 and the second processor 680 may be incorporated or integrated into a single system-on-chip. For example, the second processor 680 may be added to the first processor 120 as a software function module (or block), thereby performing the disclosure.

For example, the user may perform an action (or operation) of intentionally dropping the electronic device 101 and re-grasping it. In the following description, although the second processor 680 is described as being connected to the first sensor 610 and the second sensor 620 to determine whether the electronic device 101 is falling, the first processor (e.g., the processor 120 in FIG. 1) of the electronic device 101 may replace the second processor 680 and determine whether the electronic device 101 is falling.

Assuming that the software latency for determining the fall of the electronic device 101 is “100 ms,” when the user lightly tosses the electronic device 101 by about 1 cm, the electronic device 101 may not recognize a grip applied to the electronic device 101 at 45 ms (e.g., may determine that the grip remains released), and may recognize the falling state of the electronic device 101 detected at 90 ms as a release of the grip on the electronic device 101, leading to a malfunction of driving the motor in reverse. Therefore, a fall malfunction of the electronic device 101 may be detected by minimizing the software latency (or delay time).

According to an embodiment of the disclosure, the second processor 680 may specify a time for detecting the fall malfunction of the electronic device 101. According to an embodiment of the disclosure, the second processor 680 may determine that a fall malfunction of the electronic device 101 occurs when a release of the user grip on the electronic device 101 is detected within a specified time (e.g., 45 ms) after the fall of the electronic device 101 is determined. According to an embodiment of the disclosure, when the fall malfunction of the electronic device is determined, the second processor 680 may not call the first processor (e.g., the processor 120 in FIG. 1). For example, the processor 120 does not wake up when the fall malfunction of the electronic device 101 occurs. Therefore, it is possible to reduce the current consumed by the processor 120 when it would otherwise be unnecessarily woken up.

According to an embodiment of the disclosure, when the second processor 680 fails to detect a grip that occurs within a short period of time (e.g., 45 ms) after the fall of the electronic device 101 is determined, it may recognize that the electronic device continues to fall based on a subsequent falling situation. When a release of the user grip on the electronic device 101 is detected thereafter, it may determine that the electronic device is in a normal falling state. According to an embodiment of the disclosure, the second processor 680 may secondarily determine whether the electronic device 101 is falling based on third information (or a measurement value) measured by the first sensor 610 after the release of the user grip on the electronic device 101 is detected. According to an embodiment of the disclosure, when it is finally determined that the electronic device 101 is falling while the user grip on the electronic device 101 remains released, the second processor 680 may operate the driving unit (e.g., the driving unit 670 in FIG. 6). According to an embodiment of the disclosure, the second processor 680 may call the processor 120 to operate the driving unit 670.

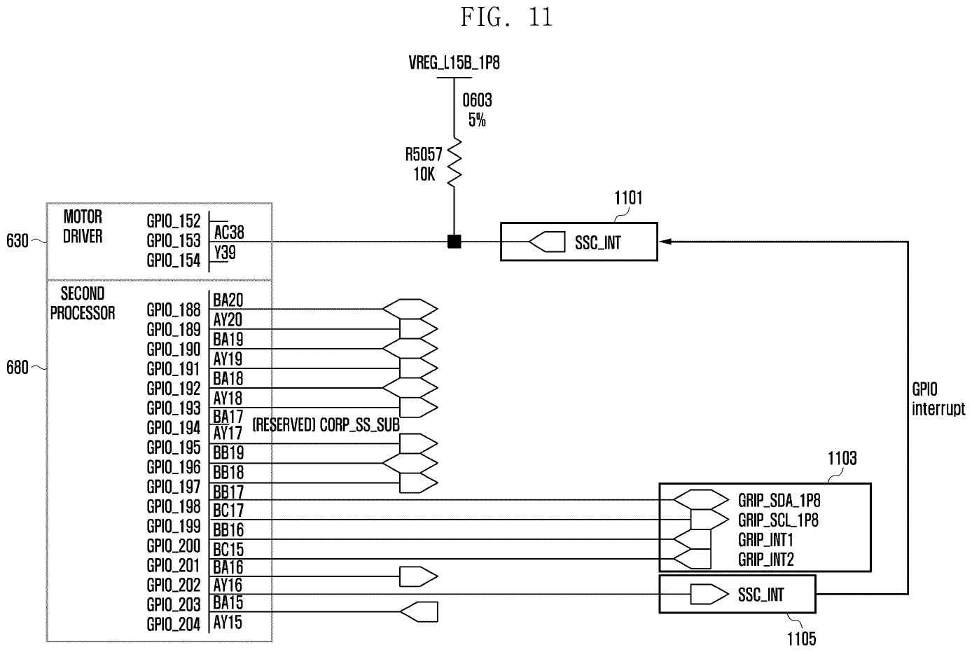

According to an embodiment of the disclosure, the electronic device (e.g., the second processor 680) may set the sensing cycle of the second sensor 620 to be short in order to detect a fall malfunction of the electronic device 101. To shorten the sensing cycle, the software latency must be reduced. To this end, as shown in FIG. 11, the second processor 680 may form an electrical path with a motor driver (e.g., the motor driver 630 in FIG. 6) included in the first processor 120. The second processor 680 may receive first and second information from the first sensor 610 and the second sensor 620, and determine in real time whether the electronic device 101 is falling.

For example, the second sensor 620 may measure a second measurement value at a first cycle (e.g., 45 ms, 90 ms, or 100 ms). When detecting a fall of the electronic device 101, the second processor 680 may change the sensing cycle of the second sensor 620 to a second cycle (e.g., 20 ms or 25 ms). The second sensor 620 may measure a second measurement value at the second cycle. Alternatively, the second processor 680 may set a short cycle for obtaining (or reading) the second measurement value from the second sensor 620. The second sensor 620 may measure whether the electronic device 101 is gripped at a set cycle (e.g., 20 ms or 25 ms). Before detecting a fall of the electronic device 101, the second processor 680 may obtain a second measurement value from the second sensor 620 at a first cycle (e.g., 45 ms, 90 ms, or 100 ms). After detecting a fall of the electronic device 101, the second processor 680 may obtain a second measurement value from the second sensor 620 at a second cycle (e.g., 20 ms or 25 ms).

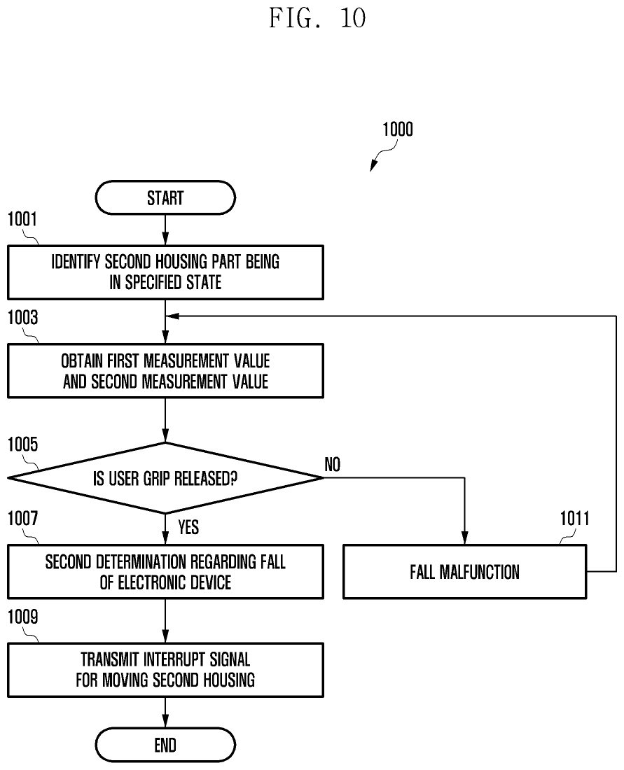

FIG. 10 is a flowchart 1000 illustrating a method for transmitting an interrupt signal in an electronic device according to an embodiment of the disclosure.

FIG. 10 may be details of the operation in FIG. 8.

Referring to FIG. 10, in operation 1001, a processor (e.g., the auxiliary processor 123 in FIG. 1 or the second processor 680 in FIG. 6) of an electronic device (e.g., the electronic device 101 in FIG. 1) according to an embodiment may identify that a second housing part (e.g., the second housing 220 in FIGS. 2A, 2B, 3A, and 3B) is in a specified state (e.g., it has moved to an extended position). According to an embodiment of the disclosure, the specified state (or the state of having moved to an extended position) may include at least one of a slide-out state, a motor-driven state, a rollable-out state, an electronic device-opened state, and/or a camera lens-driven state. For example, the electronic device 101 may include a housing including a first housing part (e.g., the first housing 210 in FIGS. 2A, 2B, 3A, and 3B) and a second housing part (e.g., the second housing 220 in FIGS. 2A, 2B, 3A, and 3B) coupled to be movable relative to the first housing part between an extended position and a retracted position. The retracted position may be a state in which the second housing 220 is completely accommodated within the first housing 210, and the extended position may be a state in which at least a portion of the second housing 220 has moved outside of the first housing 210. The extended position may include a state in which the second housing 220 is completely or partially (e.g., an intermediate state) slid out from the first housing 210. According to an embodiment of the disclosure, a state in which the second housing 220 has moved to the extended position may be expressed as a slide-in state, a retracted state, or a first state, a state in which the second housing 220 has moved to the retracted position may be expressed as a slide-out state, an extended state, or a second state, and an intermediate state in which only a portion of the housing is slid out may be expressed as a sliding state or a third state.

In operation 1003, the second processor 680 may obtain a first measurement value and a second measurement value. According to an embodiment of the disclosure, the second processor 680 may obtain a first measurement value (or information, sensed value, or sensor data) related to the movement of the electronic device 101 from a first sensor (e.g., the first sensor 610 in FIG. 6). The first sensor 610 may refer to an acceleration sensor, a gyro sensor, or a 6-axis sensor. The first sensor 610 may detect the movement of the electronic device 101 and transmit measured first measurement value to the second processor 680. Alternatively, the second processor 680 may read the first measurement value measured by the first sensor 610. The second processor 680 may detect the movement of the electronic device 101 by further using measurement values of a plurality of sensors, in addition to the first sensor 610.

According to an embodiment of the disclosure, the second processor 680 may obtain a second measurement value (or information, sensing value, or sensor data) related to a user grip on the electronic device 101 from a second sensor (e.g., the second sensor 620 in FIG. 6). Here, the user grip may refer to a user's action of holding the electronic device 101. For example, the second sensor 620 may refer to a grip sensor, a contact detection sensor, or a grip detection sensor. The second sensor 620 may transmit the second measurement value obtained by detecting a user grip on the electronic device 101 to the second processor 680. Alternatively, the second processor 680 may read the second measurement value measured by the second sensor 620. The second processor 680 may detect the user grip on the electronic device 101 by further using measurement values of a plurality of sensors, in addition to the second sensor 660.

In operation 1005, the second processor 680 may determine whether the user grip on the electronic device 101 has been released. According to an embodiment of the disclosure, when the second processor 680 determines that the electronic device 101 is falling (or detects or predicts a fall) based on the first measurement value, the second processor 680 may determine whether the user grip on the electronic device 101 has been released based on the second measurement value. The second processor 680 may simultaneously or sequentially determine the fall of the electronic device 101 and the release of the user grip on the electronic device 101. The second processor 680 may determine whether the user grip on the electronic device 101 has been released within a specified time after detecting a fall of the electronic device 101. The specified time may be configured as a default value for the electronic device 101 or may be changed based on user input.

According to an embodiment of the disclosure, when it is determined that the user grip on the electronic device 101 has been released, the processor (e.g., the second processor 680) of the electronic device may perform operation 1007, and when it is determined that the user grip on the electronic device 101 has not been released, it may perform operation 1011.

When it is determined that the user grip on the electronic device 101 has been released, the second processor 680 may determine a second fall (or final fall) of the electronic device 101 in operation 1007. The second processor 680 may make a second determination as to whether the electronic device 101 is falling after a specified time from the first fall of the electronic device 101 and the release of the user grip on the electronic device 101. According to an embodiment of the disclosure, the second processor 680 may obtain a third measurement value obtained by detecting the movement of the electronic device 101 from the first sensor 610 and determine whether the electronic device 101 is in a final falling state, based on the third measurement value.

In operation 1009, the second processor 680 may transmit an interrupt signal for moving the second housing 220 when the electronic device 101 is determined to be in a final falling state. In an embodiment of the disclosure, the second processor 680 may form an electrical path with a motor driver (e.g., the motor driver 630 in FIG. 6) included in the first processor (e.g., the processor 120 in FIG. 1). In an embodiment of the disclosure, the second processor 680 may directly transmit an interrupt signal to the motor driver 630. The interrupt signal may be transmitted from the second processor 680 to the motor driver 630 via an interface (or pin) through which the second processor 680 and the motor driver 630 are directly connected in hardware. Alternatively, the second processor 680 may call the first processor 120 to operate the driving unit 670.

According to an embodiment of the disclosure, the first processor 120 may be woken up upon a call from the second processor 680 and may transmit a motor drive command to the motor driver 630 to operate the driving unit 670. Alternatively, instead of waking up the entire first processor 120, only a part of the kernel including the motor driver 630 may be woken up to transmit a motor drive command to operate the driving unit 670.

When it is determined that the user grip on the electronic device 101 is not released, the second processor 680 may determine it to be a fall malfunction in operation 1011. The user may perform an action (or operation) of intentionally dropping the electronic device 101 and re-grasping it. When it is determined that the user grip on the electronic device 101 is not released, the second processor 680 may determine that the electronic device 101 is not in a falling state. When the user grip on the electronic device 101 is not released, the second processor 680 may determine it to be a fall malfunction. When the fall malfunction is determined, the second processor 680 may not call the first processor 120. Alternatively, when the electronic device 101 is determined not to be in a final falling state, the second processor 680 may not call the first processor 120. When the fall malfunction of the electronic device 101 is determined, the second processor 680 may return to operation 1003 and continue to determine whether the electronic device 101 is falling and the grip has been released.

According to an embodiment of the disclosure, the state of the second housing 220 of the electronic device 101 may change. The second processor 680 may determine the state of the second housing 220 and, when the second housing 220 is not in the extended position, terminate the process without returning to operation 1003.

FIG. 11 is a diagram illustrating a hardware connection between a driving unit and a second processor in an electronic device according to an embodiment of the disclosure.

Referring to FIG. 11, a second processor (e.g., the second processor 680 in FIG. 6) of an electronic device (e.g., the electronic device 101 in FIG. 1) according to an embodiment may form an electrical path with a motor driver (e.g., the motor driver 630 in FIG. 6) included in a first processor (e.g., the processor 120 in FIG. 1). GPIO_203 (1105) of the second processor 680 may directly transmit an interrupt signal to GPIO_153 (1101) of the motor driver 630. The interrupt signal may be transmitted from the second processor 680 to the motor driver 630 via an interface through which the second processor 680 and the motor driver 630 are directly connected in hardware. The second processor 680 may be directly connected in hardware to the interface 1103 of a first sensor (e.g., the first sensor 610 in FIG. 6) and a second sensor (e.g., the second sensor 620 in FIG. 6).

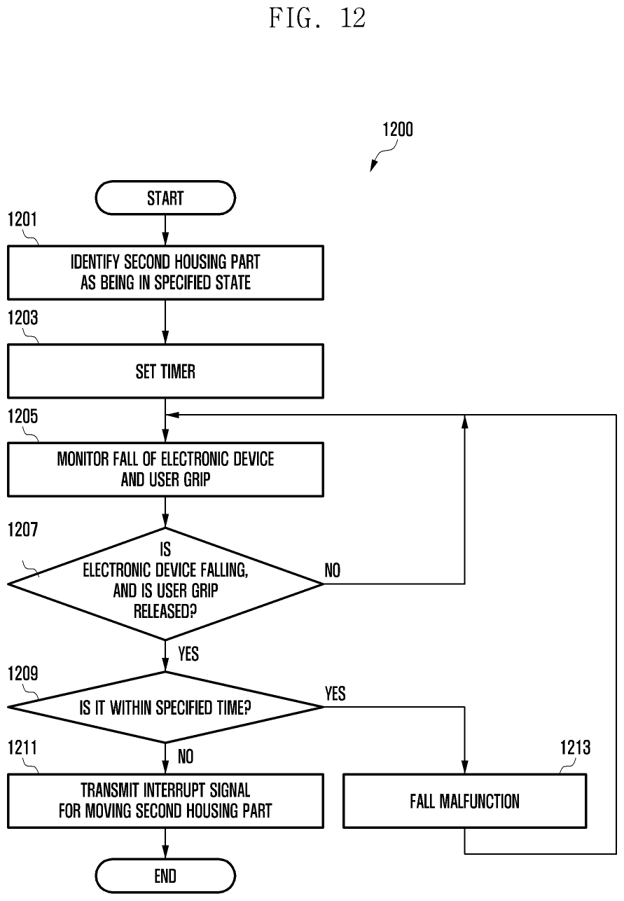

FIG. 12 is a flowchart 1200 illustrating a method for monitoring a fall and user grip and transmitting an interrupt signal in an electronic device according to an embodiment of the disclosure.

FIG. 12 may be details of operation in FIG. 8.

Referring to FIG. 12, in operation 1201, a processor (e.g., the auxiliary processor 123 in FIG. 1 or the second processor 680 in FIG. 6) of an electronic device (e.g., the electronic device 101 in FIG. 1) according to an embodiment may identify a second housing part (e.g., the second housing 220 in FIGS. 2A, 2B, 3A, and 3B) as being in a specified state. The specified state (or extended position) may include at least one of a slide-out state, a motor-driven state, a rollable-out state, an electronic device-opened state, and/or a camera lens-driven state. For example, the electronic device 101 may include a first housing part (e.g., the first housing 210 in FIGS. 2A, 2B, 3A, and 3B) and a second housing part (e.g., the second housing 220 in FIGS. 2A, 2B, 3A, and 3B) coupled to be movable relative to the first housing part between an extended position and a retracted position. The retracted position may be a state in which the second housing 220 is completely accommodated within the first housing 210, and the extended position may be a state in which at least a portion of the second housing 220 has moved outside of the first housing 210. The extended position may include a state in which the second housing 220 is completely or partially (e.g., an intermediate state) slid out from the first housing 210.

According to an embodiment of the disclosure, although the disclosure is illustrated as being performed by the second processor 680 below, the disclosure may also be performed by the first processor (e.g., the processor 120 in FIG. 1). According to an embodiment of the disclosure, the first processor 120 and the second processor 680 may be incorporated or integrated into a single system-on-chip (SoC). For example, the second processor 680 may be added to the first processor 120 as a software function module (or block), thereby performing the disclosure. The first processor 120 may be an application processor, and the second processor 680 may consume less power than the first processor 120.

In operation 1203, the second processor 680 may set a timer. The second processor 680 may start a timer to determine a fall malfunction. The timer may be set to a specified time. The specified time may be a default value set in the electronic device 101 or may be changed based on user input.

In operation 1205, the second processor 680 may monitor a fall and user grip on the electronic device 101. The second processor 680 may obtain a first measurement value related to the movement of the electronic device 101 from a first sensor (e.g., the first sensor 610 in FIG. 6). The second processor 680 may monitor whether the electronic device 101 is falling based on the first measurement value. The second processor 680 may obtain a second measurement value related to a user grip on the electronic device 101 from a second sensor (e.g., the second sensor 620 in FIG. 6). The second processor 680 may monitor whether a user grip on the electronic device 101 has been released based on the second measurement value.

In operation 1207, the second processor 680 may determine whether the electronic device 101 is falling and whether the user grip has been released. When it is determined that the electronic device 101 is falling and that the user grip has been released, the second processor 680 may perform operation 1209, and when it is determined that the electronic device 101 is not falling or that the user grip has not been released, it may perform operation 1205. When it is determined that the electronic device 101 is not falling or that the user grip has not been released, the second processor 680 may return to operation 1205, thereby monitoring a fall and user grip on the electronic device 101.

According to an embodiment of the disclosure, the state of the second housing 220 of the electronic device 101 may change. The second processor 680 may determine the state of the second housing 220 and, when the second housing 220 is not in a moving state, terminate the process without returning to operation 1205.

When it is determined that the electronic device 101 is falling and that the user grip has been released, the second processor 680 may determine whether a specified time has elapsed in operation 1209. The second processor 680 may determine whether the electronic device 101 is falling and that the user grip is released even after the specified time set in the timer. When the specified time has elapsed, the second processor 680 may perform operation 1211, and when the specified time has not elapsed (e.g., within the specified time), it may perform operation 1213.

When the specified time has elapsed, the second processor 680 may transmit an interrupt signal for movement of the second housing part in operation 1211. The second processor 680 may form an electrical path with a motor driver (e.g., the motor driver 630 in FIG. 6) included in the first processor (e.g., the processor 120 in FIG. 1). The second processor 680 may directly transmit an interrupt signal to the motor driver 630. The interrupt signal may be transmitted from the second processor 680 to the motor driver 630 via an interface (or pin) through which the second processor 680 and the motor driver 630 are directly connected in hardware. Alternatively, the second processor 680 may call the first processor 120 to operate the driving unit 670.

When the specified time has not elapsed, the second processor 680 may determine it to be a fall malfunction of the electronic device 101 in operation 1213. When the fall of the electronic device 101 and the release of the user grip occurs within the specified time, it may indicate that the user intentionally and repeatedly drops the electronic device 101 and re-grasps it. When a fall malfunction of the electronic device 101 is determined, the second processor 680 may not call the first processor 120. When a fall malfunction of the electronic device 101 is determined, the second processor 680 may return to operation 1205 and continue to monitor a fall of the electronic device 101 and a user grip.

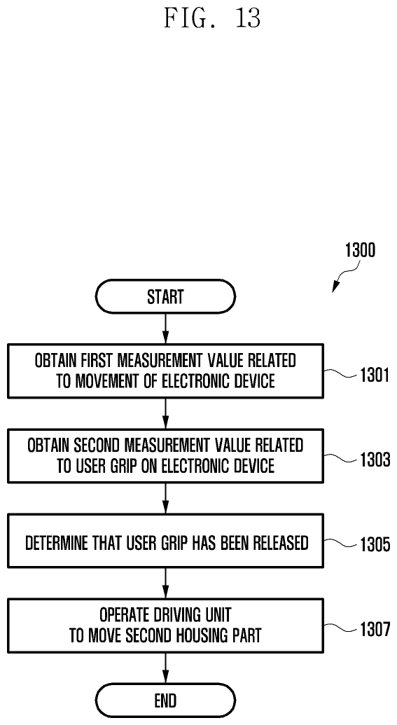

FIG. 13 is a flowchart 1300 illustrating a method for controlling a driving unit based on a fall and user grip in an electronic device according to an embodiment of the disclosure.

Referring to FIG. 13, in operation 1301, a processor (e.g., the processor 120 in FIG. 1) of an electronic device (e.g., the electronic device 101 in FIG. 1) according to an embodiment may obtain a first measurement value related to the movement of the electronic device 101. The processor may include a first processor 120 or a second processor (e.g., the auxiliary processor 123 in FIG. 1 or the second processor 680 in FIG. 6). The first processor 120 may be an application processor, and the second processor 680 may consume less power than the first processor 120. The first processor 120 or the second processor 680 may be incorporated or integrated into a single system-on-chip (SoC). The first processor 120 or the second processor 680 may be configured to operate a driving unit (e.g., the driving unit 670 in FIG. 6) of the electronic device 101.

Operations 1301 to 1307 may be performed by the first processor 120 or the second processor 680. However, the following description will describe operations 1301 to 1307 as performed by the first processor 120. The disclosure is not limited to the description.

The first processor 120 may obtain a first measurement value (or sensing value or sensor data) from a first sensor (e.g., the first sensor 610 in FIG. 6). The first sensor 610 may refer to an acceleration sensor, a gyro sensor, or a 6-axis sensor. The first sensor 610 may detect the movement of the electronic device 101 and transmit measured first measurement value to the first processor 120. Alternatively, the first processor 120 may read the first measurement value measured by the first sensor 610.

In operation 1303, the first processor 120 may obtain a second measurement value related to a user grip on the electronic device 101. The first processor 120 may obtain the second measurement value (or sensing value or sensor data) from a second sensor (e.g., the second sensor 620 in FIG. 6). Here, the user grip may refer to a user's action of holding the electronic device 101. For example, the second sensor 620 may refer to a grip sensor, a contact detection sensor, or a grip detection sensor. The second sensor 620 may transmit a second measurement value obtained by detecting a user grip on the electronic device 101 to the first processor 120. Alternatively, the first processor 120 may read the second measurement value measured by the second sensor 620.

Although the drawing illustrates that operation 1303 is performed after operation 1301, operations 1301 and 1303 may be performed simultaneously. Alternatively, operation 1303 may be performed first, followed by operation 1301. The disclosure is not limited to the drawing.

In operation 1305, the first processor 120 may determine that the user grip has been released. The first processor 120 may determine whether the electronic device 101 is falling based on the first measurement value. The first processor 120 may determine whether the user grip on the electronic device 101 has been released based on the second measurement value. According to an embodiment of the disclosure, when the second housing part included in the electronic device 101 is in an extended position, the first processor 120 may determine whether the electronic device 101 is falling and whether the user grip on the electronic device 101 has been released. The retracted position may be a state in which the second housing 220 is completely accommodated within the first housing 210, and the extended position may be a state in which at least a portion of the second housing 220 has moved outside of the first housing 210. The extended position may include a state in which the second housing 220 is completely or partially (e.g., an intermediate state) slid out from the first housing 210.

According to an embodiment of the disclosure, when the first processor 120 determines first that the electronic device 101 is falling (or detects or predicts a fall) based on the first measurement value, it may determine whether the user grip on the electronic device 101 has been released based on the second measurement value. The first processor 120 may simultaneously or sequentially determine the fall of the electronic device 101 and the release of the user grip on the electronic device 101. The first processor 120 may determine whether the user grip on the electronic device 101 has been released within a specified time after detecting the fall of the electronic device 101.

In operation 1307, the first processor 120 may operate a driving unit (e.g., the driving unit 670 in FIG. 6) to move the second housing 220 (or the second housing part). The first processor 120 may operate the driving unit 670 when it is determined that the electronic device 101 is falling and that the user grip on the electronic device 101 has been released. The first processor 120 may form an electrical path with a motor driver (e.g., the motor driver 630 in FIG. 6). The first processor 120 may directly transmit an interrupt signal to the motor driver 630. The interrupt signal may be transmitted from the first processor 120 to the motor driver 630 via an interface (or pin) through which the first processor 120 and the motor driver 630 are directly connected in hardware.

The motor driver 630 may transmit a motor drive command to the driving unit 670 to operate the driving unit. The motor driver 630 may be included in a part of a software module (e.g., a kernel (e.g., the kernel 750 in FIG. 7)). When the first processor 120 is in a sleep state, it may wake up and transmit a motor drive command to the motor driver 630 to operate the driving unit 670. Alternatively, instead of waking up the entire first processor 120, only a part of the kernel including the motor driver 630 may wake up and transmit a motor drive command to operate the driving unit 670.

For example, the motor driver 630 may transmit, to the motor driver IC, a command to perform a reverse rotation at the maximum possible speed. The driving unit 670 may move (e.g., reverse-rotate) the second housing 220 according to the command transmitted to the motor driver IC. For example, when the first processor 120 detects a fall of the electronic device 101 in the state in which the second housing 220 is completely slid out of the first housing 210 or at least a portion of the second housing 220 is slid out of the first housing 210, it may quickly rotate the driving unit 670 in reverse to minimize damage to the electronic device 101.

According to an embodiment of the disclosure, the first processor 120 may obtain a third measurement value related to the movement of the electronic device 101 in the state of a first fall of the electronic device 101 and a release of the user grip on the electronic device 101. The third measurement value may be a value obtained after the first measurement value. When the first processor 120 determines that the electronic device 101 is falling and that the user grip on the electronic device 101 has been released, it may make a second determination (or final determination) as to whether the electronic device 101 is falling. For example, the first processor 120 may make a second determination as to whether the electronic device 101 is falling after a specified time from the first fall of the electronic device 101 and the release of the user grip on the electronic device 101. The specified time may be configured to identify a fall malfunction rather than a fall of the electronic device 101. For example, the user may perform an action (or operation) of intentionally dropping the electronic device 101 and re-grasping it. When it is determined that the electronic device 101 is falling while the user grip on the electronic device 101 remains released even after the specified time, the first processor 120 may determine that the electronic device 101 is actually falling, not a fall malfunction. The first processor 120 may determine whether the electronic device 101 is in a final falling state, based on the obtained third measurement value. When it is determined that the electronic device 101 is in a final falling state, the first processor 120 may operate the driving unit 670.

According to an embodiment of the disclosure, a method for operating an electronic device 101 including a first housing part 210 and a second housing 220 coupled to be movable relative to the first housing part between an extended position and a retracted position may include obtaining, by a second processor 680 of the electronic device, first information related to movement of the electronic device using a first sensor 610 of the electronic device, obtaining, by the second processor 680 of the electronic device, second information related to a user grip on the electronic device using a second sensor 620 of the electronic device, and requesting, by the second processor 680, a first processor 120 of the electronic device to operate a driving unit 670 of the electronic device to move the second housing part from the extended position to the retracted position, based on the obtained first and second information, while the second housing part is in the extended position.

The requesting may include requesting the first processor to operate the driving unit to move the second housing part from the extended position to the retracted position, based on the first information indicating that the electronic device is falling in a state in which the user grip has been released from the electronic device based on the second information, while the second housing part is in the extended position.

The first processor may be an application processor, and the second processor may be a processor that consumes less power than the first processor.

The first processor and the second processor may be incorporated or integrated into a single system-on-chip.

The retracted position may be a state in which the second housing part is substantially completely accommodated within the first housing part, and the extended position may be a state in which at least a portion of the second housing part has moved outside of the first housing part.

The method may further include obtaining second information related to the user grip on the electronic device within a specified time according to the obtained first information, obtaining third information related to the movement of the electronic device after the specified time in a state in which the user grip on the electronic device has been released based on the obtained second information, and requesting the first processor to operate the driving unit when it is determined that the electronic device is falling based on the obtained third information.

The method may further include obtaining second information related to the user grip on the electronic device within a specified time according to the obtained first information and, when the user grip on the electronic device has not been released based on the obtained second information, determining that the electronic device is not actually falling, thereby not requesting the first processor to operate the driving unit.

A computer-readable recording medium having recorded thereon a program for causing a processor to execute a method for operating an electronic device 101 including a first housing part 210 and a second housing 220 coupled to be movable relative to the first housing part between an extended position and a retracted position may include a program for executing operations of obtaining a first measurement value related to the movement of the electronic device using the first sensor, obtaining a second measurement value related to the user grip on the electronic device using the second sensor, and operating the driving unit to move the second housing part when it is determined that the electronic device is falling and that the user grip has been released based on the obtained first and second measurement values.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a housing comprising a first housing part and a second housing part coupled to be movable relative to the first housing part between an extended position and a retracted position;
a first sensor configured to detect movement of the electronic device;
a second sensor configured to detect a user grip on the electronic device;
a driving unit configured to move the second housing part between the extended position and the retracted position;
memory, comprising one or more storage media, storing instructions;
a first processor communicatively coupled to the driving unit and the memory; and
a second processor communicatively coupled to the first sensor, the second sensor, and the first processor,
wherein the instructions, when executed by the second processor, cause the electronic device to:
obtain first information related to movement of the electronic device using the first sensor,
obtain second information related to a user grip on the electronic device using the second sensor, and
request the first processor to operate the driving unit to move the second housing part from the extended position to the retracted position, based on the obtained first and second information, while the second housing part is in the extended position.

2. The electronic device of claim 1, wherein the instructions, when executed by the second processor, further cause the electronic device to request the first processor to operate the driving unit to move the second housing part from the extended position to the retracted position, based on the first information indicating that the electronic device is falling in a state in which the user grip has been released from the electronic device based on the second information, while the second housing part is in the extended position.

3. The electronic device of claim 1,
wherein the first processor includes an application processor, and
wherein the second processor includes a processor that consumes less power than the first processor.

4. The electronic device of claim 1, wherein the first processor and the second processor are incorporated or integrated into a single system-on-chip.

5. The electronic device of claim 1,
wherein the retracted position corresponds to a state in which the second housing part is substantially completely accommodated within the first housing part, and
wherein the extended position corresponds to a state in which at least a portion of the second housing part has moved outside of the first housing part.

6. The electronic device of claim 1, wherein the instructions, when executed by the second processor, further cause the electronic device to:
obtain second information related to the user grip on the electronic device within a specified time according to the obtained first information;
obtain third information related to the movement of the electronic device after the specified time in a state in which the user grip on the electronic device has been released based on the obtained second information; and
when it is determined that the electronic device is falling based on the obtained third information, request the first processor to operate the driving unit.

7. The electronic device of claim 1, wherein the instructions, when executed by the second processor further cause the electronic device to:
obtain second information related to the user grip on the electronic device within a specified time according to the obtained first information; and
when the user grip on the electronic device has not been released based on the obtained second information, determine that the electronic device is not actually falling, thereby not requesting the first processor to operate the driving unit.

8. An electronic device comprising:
a housing comprising a first housing part and a second housing part coupled to be movable relative to the first housing part;
a first sensor configured to detect movement of the electronic device;
a second sensor configured to detect a user grip on the electronic device;
a driving unit configured to provide driving force for movement of the second housing part;
memory, comprising one or more storage media, storing instructions; and
at least one processor communicatively coupled to the first sensor, the second sensor, the driving unit, and the memory,
wherein the instructions, when executed by the at least one processor individually or collectively, cause the electronic device to:
obtain a first measurement value related to the movement of the electronic device using the first sensor,
obtain a second measurement value related to the user grip on the electronic device using the second sensor, and
operate the driving unit to move the second housing part when it is determined that the electronic device is falling and that the user grip has been released based on the obtained first and second measurement values.

9. The electronic device of claim 8,
wherein the at least one processor comprises:
a first processor or a second processor, and
wherein the first processor or the second processor is configured to operate the driving unit.

10. A method for operating an electronic device comprising a first housing part and a second housing part coupled to be movable relative to the first housing part between an extended position and a retracted position, the method comprising:
obtaining, by a second processor of the electronic device, first information related to movement of the electronic device using a first sensor of the electronic device;
obtaining, by the second processor, second information related to a user grip on the electronic device using a second sensor of the electronic device; and
requesting, by the second processor, a first processor of the electronic device to operate a driving unit of the electronic device to move the second housing part from the extended position to the retracted position, based on the obtained first and second information, while the second housing part is in the extended position.

11. The method of claim 10, wherein the requesting comprises:
requesting the first processor to operate the driving unit to move the second housing part from the extended position to the retracted position, based on the first information indicating that the electronic device is falling in a state in which the user grip has been released from the electronic device based on the second information, while the second housing part is in the extended position.

12. The method of claim 10,
wherein the first processor includes an application processor, and
wherein the second processor includes a processor that consumes less power than the first processor.

13. The method of claim 10, wherein the first processor and the second processor are incorporated or integrated into a single system-on-chip.

14. The method of claim 10,
wherein the retracted position corresponds to a state in which the second housing part is substantially completely accommodated within the first housing part, and
wherein the extended position corresponds to a state in which at least a portion of the second housing part has moved outside of the first housing part.

15. The method of claim 10, further comprising:
obtaining second information related to the user grip on the electronic device within a specified time according to the obtained first information;
obtaining third information related to the movement of the electronic device after the specified time in a state in which the user grip on the electronic device has been released based on the obtained second information; and
requesting the first processor to operate the driving unit when it is determined that the electronic device is falling based on the obtained third information.

16. One or more non-transitory computer-readable storage media storing one or more computer programs including computer-executable instruction that, when executed by one or more processors of an electronic device individually or collectively, cause the electronic device to perform operations for operating the electronic device comprising a first housing part and a second housing part coupled to be movable relative to the first housing part between an extended position and a retracted position, the operations comprising:
obtaining, by a second processor of the electronic device, first information related to movement of the electronic device using a first sensor of the electronic device;
obtaining, by the second processor, second information related to a user grip on the electronic device using a second sensor of the electronic device; and
requesting, by the second processor, a first processor of the electronic device to operate a driving unit of the electronic device to move the second housing part from the extended position to the retracted position, based on the obtained first and second information, while the second housing part is in the extended position.

17. The one or more non-transitory computer-readable storage media of claim 16, the operations further comprising:
requesting the first processor to operate the driving unit to move the second housing part from the extended position to the retracted position, based on the first information indicating that the electronic device is falling in a state in which the user grip has been released from the electronic device based on the second information, while the second housing part is in the extended position.

18. The one or more non-transitory computer-readable storage media of claim 16,
wherein the first processor includes an application processor, and
wherein the second processor includes a processor that consumes less power than the first processor.

19. The one or more non-transitory computer-readable storage media of claim 16, wherein the first processor and the second processor are incorporated or integrated into a single system-on-chip.

20. The one or more non-transitory computer-readable storage media of claim 16,
wherein the retracted position corresponds to a state in which the second housing part is substantially completely accommodated within the first housing part, and
wherein the extended position corresponds to a state in which at least a portion of the second housing part has moved outside of the first housing part.
